(19) United States
(12) Patent Application Publication
(10) Pub. No.: US 2026/0164341 A1
(43) Pub. Date: Jun. 11, 2026

(54) STANDALONE ON-DEMAND SIB1 CONFIGURATIONS

(71) Applicant: QUALCOMM Incorporated, San Diego, CA (US)

(72) Inventors: Jae Ho RYU, San Diego, CA (US); Hung Dinh LY, San Diego, CA (US); Navid ABEDINI, Basking Ridge, NJ (US); Jianghong LUO, Skillman, NJ (US)

(21) Appl. No.: 18/970,836

(22) Filed: Dec. 5, 2024

(51) Int. Cl. H04W 48/16; H04L 5/14; H04W 52/02

(52) U.S. Cl. CPC H04W 48/16; H04L 5/14; H04W 52/0235

(57) ABSTRACT

Standalone OD-SIB1 configurations are described. An apparatus is configured to receive, from a network node, a MIB indicative of an UL WUS configuration. The apparatus is configured to provide, for the network node, an UL WUS in accordance with the UL WUS configuration. The apparatus is configured to receive, from the network node and based on the UL WUS configuration, a SIB1. The received SIB1 is associated with the UL WUS. Another apparatus is configured to transmit, for a UE, a MIB indicative of an UL WUS configuration. The apparatus is configured to receive, from the UE, an UL WUS in accordance with the UL WUS configuration. The apparatus is configured to transmit, for the UE and based on the UL WUS configuration, a SIB1.

### TECHNICAL FIELD

The present disclosure relates generally to communication systems, and more particularly, to wireless systems utilizing network energy savings (NES).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be, or may comprise, a user equipment (UE). The apparatus receives, from a network node, a master information block (MIB) indicative of an uplink (UL) wake up signal (WUS) configuration. The apparatus also receives, from the network node and based on the UL WUS configuration, a system information block (SIB) type 1 (SIB1). The apparatus may also provide, for the network node, an UL WUS in accordance with the UL WUS configuration, where the received SIB1 is associated with the UL WUS.

In the aspect, the method includes receiving, from a network node, a MIB indicative of an UL WUS configuration. The method also includes receiving, from the network node and based on the UL WUS configuration, a SIB1. The method may also include providing, for the network node, an UL WUS in accordance with the UL WUS configuration, where the received SIB1 is associated with the UL WUS.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating examples of on-demand (OD) SIB1 (OD-SIB1) and UL WUS configurations.

FIG. 5 is a diagram illustrating examples of random access channel (RACH) configurations.

FIG. 6 is a diagram illustrating an example of a RACH configuration table.

FIG. 7 is a call flow diagram for wireless communications, in accordance with various aspects of the present disclosure.

FIG. 8 is a diagram of an UL WUS configuration for standalone OD-SIB1 configurations, in accordance with various aspects of the present disclosure.

FIG. 9 is a diagram of frequency domain resource indications for standalone OD-SIB1 configurations, in accordance with various aspects of the present disclosure.

FIG. 10 is a diagram of cyclic prefix (CP) and sub-carrier spacing (SCS) indications for standalone OD-SIB1 configurations, in accordance with various aspects of the present disclosure.

FIG. 11 is a diagram of cell selections and handovers for standalone OD-SIB1 configurations, in accordance with various aspects of the present disclosure.

FIG. 12 is a diagram of switching between always-on SIB1 and OD-SIB 1 for standalone OD-SIB1 configurations, in accordance with various aspects of the present disclosure.

FIG. 13 is a flowchart of a method of wireless communication.

FIG. 14 is a flowchart of a method of wireless communication.

FIG. 15 is a diagram illustrating an example of a hardware implementation for an example apparatus and/or network entity.

FIG. 16 is a diagram illustrating an example of a hardware implementation for an example network entity.

### DETAILED DESCRIPTION

Wireless communication networks may be designed to support communications between network nodes (e.g., base stations, gNBs, etc.)/network entities (e.g., in a core network, network nodes, etc.) and UEs. A UE may receive various types of system information (SI), e.g., via SIB1, in a wireless communication network, e.g., 5G NR or others, through different channels and mechanisms. An anchor cell (e.g., a network node) may provide universal coverage for an idle/inactive state UE supporting on-demand SIB1, e.g., the anchor cell provides always-on SSB/SIB1. An overlaid OD-SIB1 cell may provide better service than the anchor cell for a connected UE. For instance, depending on the UE location, an OD-SIB1 cell may provide better signal quality than the anchor cell, and the OD-SIB1 cell may have larger available bandwidth than the anchor cell. The anchor cell may provide a configuration for an OD-SIB1 procedure for an overlaid OD-SIB1 cell, e.g., via an UL WUS signal configuration and physical downlink control channel (PDCCH)/physical downlink shared channel (PDSCH) configuration for OD-SIB1 transmission. In some cases, an idle/inactive state UE may camp on a cell and monitor SSBs for cell selection/reselection, acquisition/reacquisition of MIB/SIB, monitoring of paging for SI updates and DL data arrival, connection setup, location registration/update, etc., as well as, monitoring a neighbor cell(s) SSB for cell selection/reselection.

However, a deployed OD-SIB1 cell may be enabled to provide an UL WUS configuration for an idle/inactive state UE; rather, an overlaid anchor cell would provide the UL WUS configuration for the OD-SIB1 cell. In cell reselection scenarios, a UE may obtain an UL WUS configuration of a new serving cell, if the new serving cell is an OD-SIB1 cell, for proper operations. If the UL WUS configuration is provided by the anchor cell and not the OD-SIB1 cell, the UE may switch to the anchor cell to obtain UL WUS configuration during cell reselection for proper operations. If the UL WUS configuration is provided via a current serving cell, such a scenario would increase backhaul coordination and SIB signaling overhead in order to provide the UL WUS configuration for multiple neighbor cells. For current and future deployments, e.g., 5G, 6G deployments, there is a need to support standalone OD-SIB1 operations without an anchor cell.

Various aspects relate generally to NES. Some aspects more specifically relate to standalone OD-SIB1 configurations. In some examples, an apparatus receives, from a network node, a MIB indicative of an UL WUS configuration. The apparatus provides, for the network node, an UL WUS in accordance with the UL WUS configuration. The apparatus receives, from the network node and based on the UL WUS configuration, a SIB1 that is associated with the UL WUS. Thus, aspects provide for support of standalone OD-SIB1 operations with a cell on which the UE camps, e.g., a NES cell where the UE is in an idle/inactive state, and without an anchor cell.

Particular aspects of the subject matter described in this disclosure can be implemented to realize one or more of the following potential advantages. In some examples, by providing the UL WUS configuration directly from an OD-SIB1 cell, the described techniques can be used to bypass communications with an anchor cell and reduce UE cell switching. In some examples, by providing the UL WUS configuration in a MIB from an OD-SIB1 cell, the described techniques can be used to reduce backhaul coordination and SIB signaling overhead.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

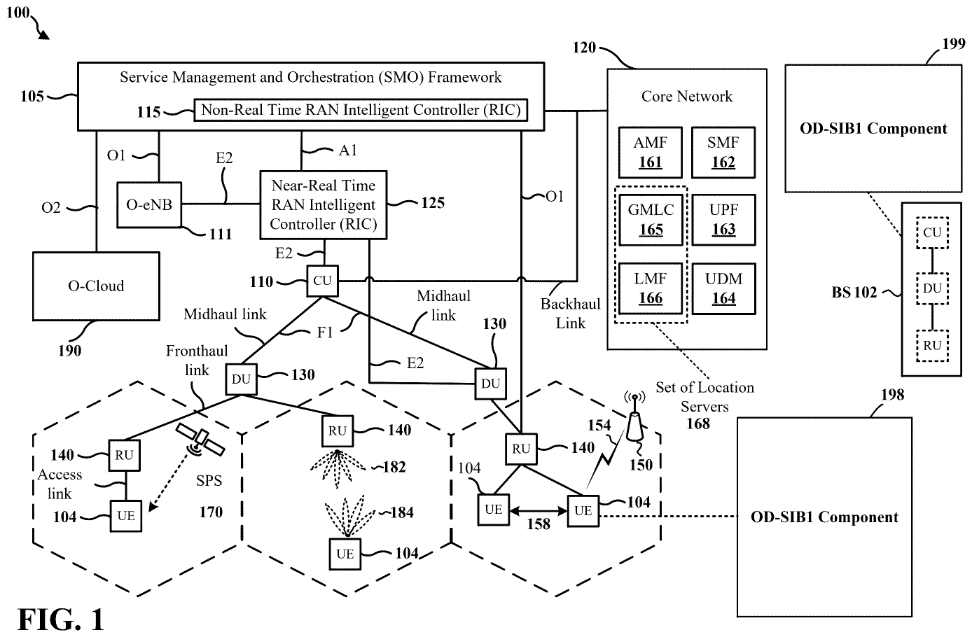

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an OD-SIB1 component 198 (“component 198”) that may be configured to receive, from a network node, a MIB indicative of an UL WUS configuration. The component 198 may be configured to receive, from the network node and based on the UL WUS configuration, a SIB1. The component 198 may also be configured to transmit/provide, for the network node, an UL WUS in accordance with the UL WUS configuration, where the received SIB1 is associated with the UL WUS. The component 198 may also be configured to transmit/provide, for the network node, an UL WUS in accordance with the UL WUS configuration and based on an absence of an indication in the MIB that the SIB1 is an always-on SIB1, where the received SIB1 is associated with the UL WUS. In certain aspects, the base station 102 may have an OD-SIB1 component 199 (“component 199”) that may be configured to transmit/provide, for a UE, a MIB indicative of an UL WUS configuration. The component 199 may be configured to transmit/provide, for the UE and based on the UL WUS configuration, a SIB1. The component 199 may also be configured to receive, from the UE, an UL WUS in accordance with the UL WUS configuration, where the transmitted SIB1 is associated with the UL WUS. The component 199 may also be configured to receive, from the UE, an UL WUS in accordance with the UL WUS configuration and based on an absence of an indication in the MIB that the SIB1 is an always-on SIB1, where the transmitted SIB1 is associated with the UL WUS. Accordingly, aspects provide for support of standalone OD-SIB1 operations with a cell on which the UE camps, e.g., a NES cell where the UE is in an idle/inactive state, and without an anchor cell. Aspects bypass communications with an anchor cell and reduce UE cell switching by providing the UL WUS configuration from an OD-SIB1 cell, and also reduce backhaul coordination and SIB signaling overhead by providing the UL WUS configuration in a MIB from an OD-SIB1 cell.

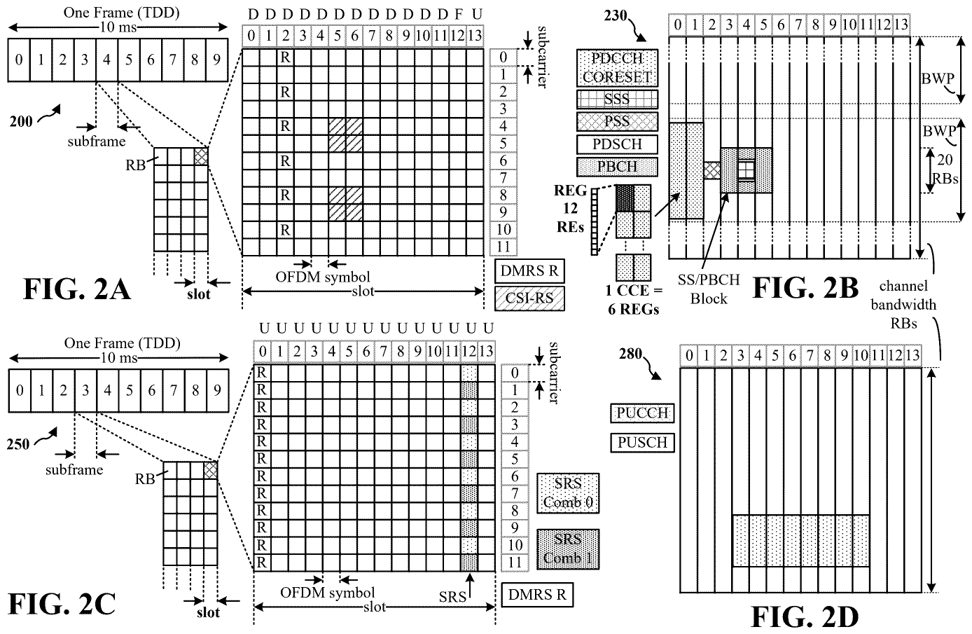

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

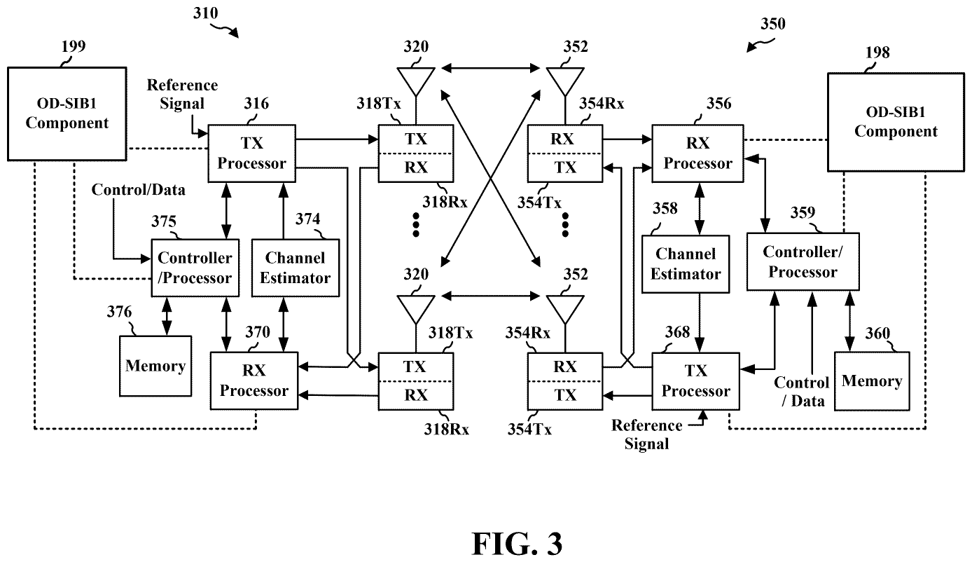

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1.

At least one of the TX processor 316, the RX processor 370, and the controller/processor 375 may be configured to perform aspects in connection with the component 199 of FIG. 1.

A UE may receive various types of SI, e.g., via SIB1, in a wireless communication network, e.g., 5G NR or others, through different channels and mechanisms. An anchor cell (e.g., a network node) may provide universal coverage for an idle/inactive state UE supporting on-demand SIB1, e.g., the anchor cell provides always-on SSB/SIB1. An overlaid OD-SIB1 cell may provide better service than the anchor cell for a connected UE. For instance, depending on the UE location, an OD-SIB1 cell may provide better signal quality than the anchor cell, and the OD-SIB1 cell may have larger available bandwidth than the anchor cell. The anchor cell may provide a configuration for an OD-SIB1 procedure for an overlaid OD-SIB1 cell, e.g., via an UL WUS signal configuration and PDCCH/PDSCH configuration for OD-SIB1 transmission. In some cases, an idle/inactive state UE may camp on a cell and monitor SSBs for cell selection/reselection, acquisition/reacquisition of MIB/SIB, monitoring of paging for SI updates and DL data arrival, connection setup, location registration/update, etc., as well as, monitoring a neighbor cell(s) SSB for cell selection/reselection. However, a deployed OD-SIB 1 cell may be enabled to provide an UL WUS configuration for an idle/inactive state UE; rather, an overlaid anchor cell would provide the UL WUS configuration for the OD-SIB1 cell. In cell reselection scenarios, a UE may obtain an UL WUS configuration of a new serving cell, if the new serving cell is an OD-SIB1 cell, for proper operations. If the UL WUS configuration is provided by the anchor cell and not the OD-SIB1 cell, the UE may switch to the anchor cell to obtain UL WUS configuration during cell reselection for proper operations. If the UL WUS configuration is provided via a current serving cell, such a scenario would increase backhaul coordination and SIB signaling overhead in order to provide the UL WUS configuration for multiple neighbor cells.

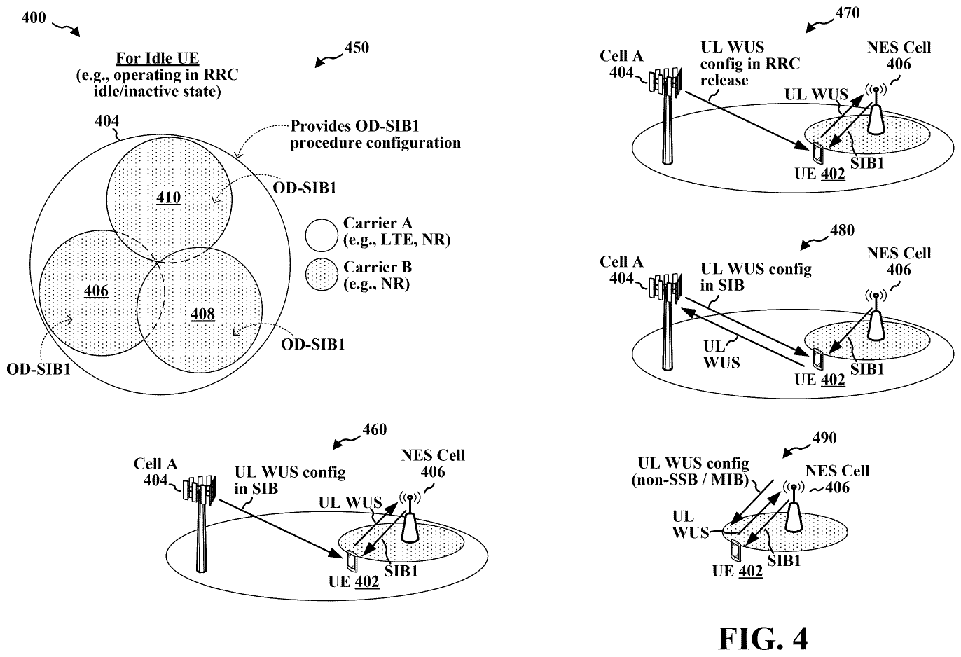

FIG. 4 is a diagram 400 illustrating examples of OD-SIB1 and UL WUS configurations. Diagram 400 shows a UE 402 with respect to coverage areas for a Cell A 404 (e.g., a Carrier A) as an anchor cell, and a NES cell 406 (e.g., a Carrier B) that may be an OD-SIB1 cell.

In a configuration 450 for the UE 402 being in an idle/inactive state for RRC, the Cell A 404 may provide an OD-SIB1 procedure configuration to the UE 402. The NES cell 406, as well additional instances thereof (e.g., a NES cell 408, a NES cell 410, etc.) may be an OD-SIB1 cell. The anchor cell (e.g., the Cell A 404) may provide universal coverage for the UE 402, in an idle/inactive state, which may support on-demand SIB1, e.g., the anchor cell provides always-on SSB/SIB1. Yet, an overlaid OD-SIB1 cell (e.g., the NES cell 406, the NES cell 408, the NES cell 410) may provide better service than the Cell A 404 for the UE 402 in a connected mode. For instance, depending on the UE 402 location, an OD-SIB 1 cell (e.g., the NES cell 406, the NES cell 408, the NES cell 410) may provide better signal quality than the anchor cell (e.g., the Cell A 404), and the OD-SIB1 cell (e.g., the NES cell 406, the NES cell 408, the NES cell 410) may have larger available bandwidth than the anchor cell (e.g., the Cell A 404) (e.g., OD-SIB1 may be a TDD cell with 100 MHz bandwidth and an anchor cell may be an FDD cell with 10 MHz bandwidth).

The Cell A 404 may provide a configuration for an OD-SIB1 procedure for an overlaid OD-SIB1 cell (e.g., the NES cell 406, the NES cell 408, the NES cell 410) via an UL WUS signal configuration and PDCCH/PDSCH configuration for OD-SIB1 transmission. In some cases, an idle/inactive state UE (e.g., the UE 402) may camp on a cell (e.g., the NES cell 406, the NES cell 408, the NES cell 410) and monitor SSBs for cell selection/reselection, acquisition/reacquisition of MIB/SIB, monitoring of paging for SI updates and DL data arrival, connection setup, location registration/update, etc., as well as, monitoring a neighbor cell(s) SSB for cell selection/reselection. With respect to UE procedures when camping on a NES cell, generally, if the UE 402 chooses the OD-SIB1 cell (e.g., the NES cell 406) using an intra-F/inter-F cell reselection procedure (e.g., as a baseline) (e.g., as the triggering condition of the UL WUS transmission), the UE 402 may trigger an UL WUS transmission. After the UE 1002 successfully receives the OD-SIB1 for the NES cell 406, and if it is a suitable cell, the UE 402 may camp in the NES cell 406, e.g., similarly as with camping on other types of cells. Regarding paging and SIB1 updates in the NES cell 406, NES UEs (e.g., the UE 402) may camp in the NES cell 406, and the UE 402 behavior may be the same as the behavior defined in a normal camped state for the other types of cells, e.g., paging reception, SIB1 updates, etc. With reference to SIB1 acquisition upon a SIB change notification in the NES cell 406, once the UE 402 camps on the NES cell 406, if the UE 402 receives a SIB change notification, the UE 402 may be expected to receive SIB1 from NES cell 406.

As one example, a configuration 460 shows the Cell A 404 providing an UL WUS configuration via SIB to the UE 402. Based on the UL WUS configuration, the UE 402 may provide an UL WUS to the NES cell 406, and the NES cell 406 may provide the UE 402 with a SIB1 in association with the UL WUS. As another example, a configuration 470 shows the Cell A 404 providing an UL WUS configuration via RRC to the UE 402. Based on the UL WUS configuration, the UE 402 may provide an UL WUS to the NES cell 406, and the NES cell 406 may provide the UE 402 with a SIB1 in association with the UL WUS. As another example, a configuration 480 shows the Cell A 404 providing an UL WUS configuration via SIB to the UE 402. Based on the UL WUS configuration, the UE 402 may provide an UL WUS to the Cell A 404. Subsequently, the NES cell 406 may provide the UE 402 with a SIB1 in association with the UL WUS provided to the Cell A 404. As another example, a configuration 490 shows the NES cell 406 providing an UL WUS configuration, via non-SSB transmission, to the UE 402. Based on the UL WUS configuration, the UE 402 may provide an UL WUS to the NES cell 406, and the NES cell 406 may provide the UE 402 with a SIB1 in association with the UL WUS.

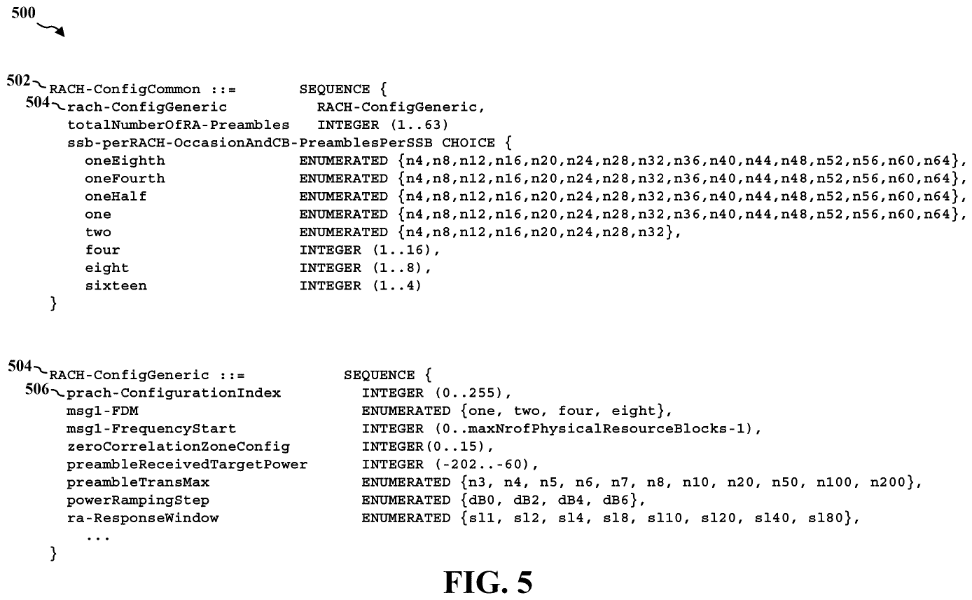

FIG. 5 is a diagram 500 illustrating examples of RACH configurations. In some cases, signaling parameters for UL WUS configurations may be provided for a UE via a RACH configuration 502. The RACH configuration 502 may include an indication of generic parameters 504 (rach-ConfigGeneric). The generic parameters 504 may include a PRACH configuration index 506 (prach-ConfigurationIndex), as well as other parameters, which may be utilized for OD-SIB1 and UL WUS configurations.

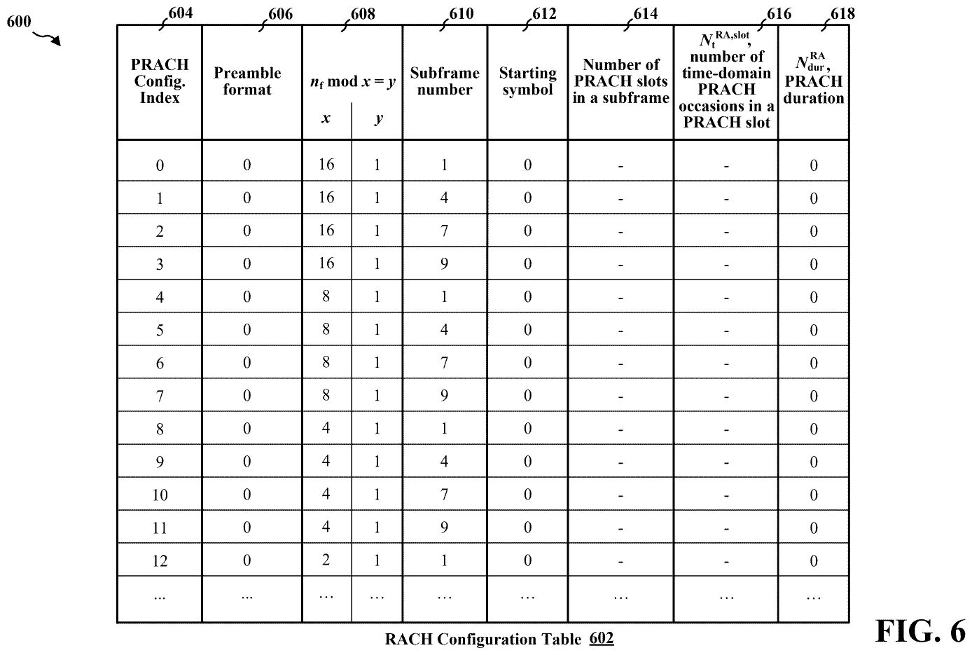

FIG. 6 is a diagram 600 illustrating an example of a RACH configuration table. As an example, a RACH configuration table 602 is shown in diagram 600. The RACH configuration table 602 may be an aspect of the generic parameters 504 (rach-ConfigGeneric) in FIG. 5, and a PRACH configuration index 604 may be an aspect of the PRACH configuration index 506 (prach-ConfigurationIndex) in FIG. 5.

As illustrated, the RACH configuration table 602 may include parameters for: the PRACH configuration index 604, a preamble format 606, a transmission frame number 608 (nₜ mod x=y), a subframe number 610, a starting symbol 612, a number of PRACH slots 614 in a subframe, a number of time-domain PRACH occasions 616

$$( {N}_{t}^{RA , slot} )$$

in a PRACH slot, a PRACH duration 618

$$( {N}_{dur}^{RA ,} ) ,$$

and/or the like.

However, a deployed OD-SIB1 cell may be enabled to provide an UL WUS configuration for an idle/inactive state UE; rather, an overlaid anchor cell would provide the UL WUS configuration for the OD-SIB1 cell. In cell reselection scenarios, a UE may obtain an UL WUS configuration of a new serving cell, if the new serving cell is an OD-SIB1 cell, for proper operations. If the UL WUS configuration is provided by the anchor cell and not the OD-SIB1 cell, the UE may switch to the anchor cell to obtain UL WUS configuration during cell reselection for proper operations. If the UL WUS configuration is provided via a current serving cell, such a scenario would increase backhaul coordination and SIB signaling overhead in order to provide the UL WUS configuration for multiple neighbor cells.

For current and future deployments, e.g., 5G, 6G deployments, there is a need to support standalone OD-SIB1 operations without an anchor cell. Aspects herein indicate configurations of UL WUS in a MIB. This effectively moves some of the information of SIB1 (RACH configuration) to the MIB. Aspects also provide for indications of always-on SIB1 or on-demand SIB1 to enable the network to switch between the two modes. Aspects herein for standalone OD-SIB1 configurations provide for support of standalone OD-SIB1 operations with a cell on which the UE camps, e.g., a NES cell where the UE is in an idle/inactive state, and without an anchor cell. Aspects bypass communications with an anchor cell and reduce UE cell switching by providing the UL WUS configuration from an OD-SIB1 cell. Aspects also reduce backhaul coordination and SIB signaling overhead by providing the UL WUS configuration in a MIB from an OD-SIB1 cell.

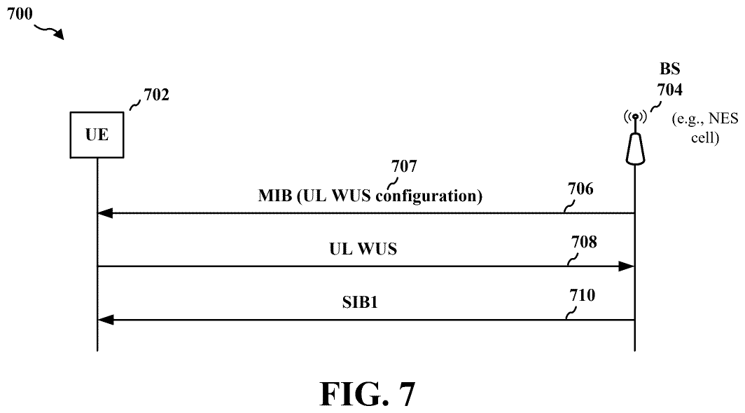

FIG. 7 is a call flow diagram 700 for wireless communications, in various aspects. Call flow diagram 700 illustrates standalone OD-SIB1 configurations for a UE (e.g., a UE 702), by way of example, that communicates with a network node (e.g., a base station 704, a gNB, etc., as shown and described herein), by way of example, which may be an NES node operating as a serving cell (e.g., an OD-SIB1 cell) providing coverage to the UE 702. While call flow diagram 700 is illustrated and described with respect to a base station, aspects include that the base station 704 may be two or more base stations, and aspects described for base stations, and for network nodes/entities herein, generally, may be performed in aggregated form and/or by one or more components in disaggregated form. Additionally, or alternatively, the aspects may be performed by the UE 702 autonomously, in addition to, and/or in lieu of, operations of a network node/base station (e.g., the NES cell/node, the base station 704).

The UE 702 may be configured to receive, and the base station 704 may be configured to transmit/provide, a MIB 706 indicative of an UL WUS configuration 707. In aspects, an SSB may comprise the MIB 706. In such aspects, the UL WUS configuration 707 may be associated with a configuration index for a set of UL WUS configurations, and a single codepoint of the MIB 706 and associated with the UL WUS configuration 707. The UL WUS configuration 707 may be associated with a configuration for at least one of a message type 1 (MSG1) frequency start offset, a number of PRACH preambles, a PRACH configuration index, a zero correlation zone configuration, a power control parameter, a random access response (RAR) window size, a PRACH SCS, a non-PRACH SCS, a set of absolute radio-frequency channel numbers (ARFCNs) associated with a set of synchronization raster points, a frequency offset, and/or the like, as described in further detail herein. The SCS of a PRACH may be based on a pre-defined SCS associated with a frequency range or a band of the network node (e.g., the base station 704), while in other examples, the SCS of a PRACH may be based on the PRACH SCS among a set of PRACH SCSs associated with the frequency range or the band of the network node (e.g., the base station 704). In such aspects, the MIB 706 may be indicative of the PRACH SCS among the set of PRACH SCSs. In some aspects, an SCS of an UL channel other than a PRACH may be based on a first SCS of an SSB that comprises the MIB 706 or a second SCS of an initial DL BWP associated with the MIB 706. In some aspects, the SCS of an UL channel other than a PRACH may be based on the non-PRACH SCS among a set of non-PRACH SCSs associated with a frequency range or a band of the network node (e.g., the base station 704) (e.g., where the MIB 706 is indicative of the non-PRACH SCS among the set of non-PRACH SCSs). To receive the MIB 706, the UE 702 may be configured to receive, from the network node (e.g., the base station 704), a PBCH during a cell selection, a cell reselection, or a handover procedure in which a provision of the SIB1 710 for a target cell from a source cell (e.g., the network node (e.g., the base station 704)) is absent. In such aspects, to receive the SIB1 710, the UE 702 may be configured to receive the SIB1 710 from the target cell based on a decode of the PBCH. In aspects, the MIB 706 may be indicative of an always-on SIB1 transmission configuration (e.g., for the SIB1 710).

The UE 702 may be configured to transmit/provide, and the base station 704 may be configured to receive, an UL WUS 708 in accordance with the UL WUS configuration 707 (e.g., indicated by the MIB 706). In some aspects, a TDD frequency domain resource for an UL BWP of the UL WUS 708 may be based on the MSG1 frequency start offset relative to a lowest PRB associated with an SSB that comprises the MIB 706. In such aspects, the MIB may be indicative of the MSG1 frequency start offset. In some aspects, an FDD frequency domain resource of the UL WUS 708 is based on an ARFCN, of the set of ARFCNs, associated with a first tone of a RACH resource in the frequency domain. In such aspects, the MIB 706 may be indicative of the ARFCN. In aspects, the UE 702 may be configured to transmit/provide, and the network node (e.g., the base station 704) may be configured to receive, the UL WUS 708 in accordance with the UL WUS configuration 707 and based on an absence of an indication in the MIB 706 that the SIB1 710 is an always-on SIB1. In such aspects, the received SIB1 (e.g., the SIB1 710) may be associated with the UL WUS 708. In aspects, a TDD frequency domain resource for an UL BWP of the UL WUS 708 may be based on an initial DL BWP associated with the MIB 706. In such aspects, a RACH occasion (RO) for the UL WUS 708 may be an initial RO of an initial UL BWP. In aspects, a CP length, associated with a determination of a RACH resource, for an UL BWP of the UL WUS 708 may be based on an SSB CP length of an SSB that comprises the MIB 706.

The UE 702 may be configured to receive, and the network node (e.g., the base station 704) may be configured to transmit/provide, a SIB1 710. In aspects, the SIB1 710 may be based on the UL WUS configuration 707, and the SIB1 710 that is received may be associated with the UL WUS 708. In aspects, to receive the SIB1 710, the UE 702 may be configured to decode the SIB1 710 based on a control resource set 0 (CORESET0) and a search space 0 configuration indicated by the MIB 706 based on a presence of an indication in the MIB 706 that the SIB1 710 is an always-on SIB1. In aspects, to receive the SIB1 710, the UE 702 may be configured to receive the SIB1 710 from a source cell (e.g., the network node (e.g., the base station 704)) during a handover procedure. Is such aspects, the UE 702 may be configured to refrain from acquiring the SIB1 710 from a target cell. In some aspects, the SIB1 710 may be associated with a change in SIB1 operation mode between an always-on SIB1 and an on-demand SIB1, where the change in SIB1 operation mode may be based on an implicit indication(s) in communications. In aspects, an implicit indication may provide for the UE 702 to be configured to decode a PBCH to re-obtain an UL WUS configuration and to then determine a SIB1 transmission mode. For example, the UE 702, to receive, as transmitted/provided by the base station 704, and based on the UL WUS configuration 707, the SIB1 710, may be configured to determine a current SIB1 operation mode associated with the network node (e.g., the base station 704) based on decoding the MIB 706, and to receive, from the network node (e.g., the base station 704), the SIB1 710 based on the current SIB1 operation mode. In some aspects, the SIB1 710 may be associated with a change in SIB1 operation mode between an always-on SIB1 and an on-demand SIB1, where the change in SIB1 operation mode is based on an explicit indication(s) in communications. In aspects, an explicit indication may provide for the UE 702 to be configured to determine a SIB1 transmission mode (e.g., always-on SIB1 or OD-SIB1) based on a bit in paging DCI. In this case, UE may not decode the PBCH. For example, the UE 702, to receive, as transmitted/provided by the base station 704, and based on the UL WUS configuration 707, the SIB1 710, may be configured to receive, from the network node (e.g., the base station 704), an indication of the change in SIB1 operation mode via a SIB1 operation mode indication bit in paging DCI.

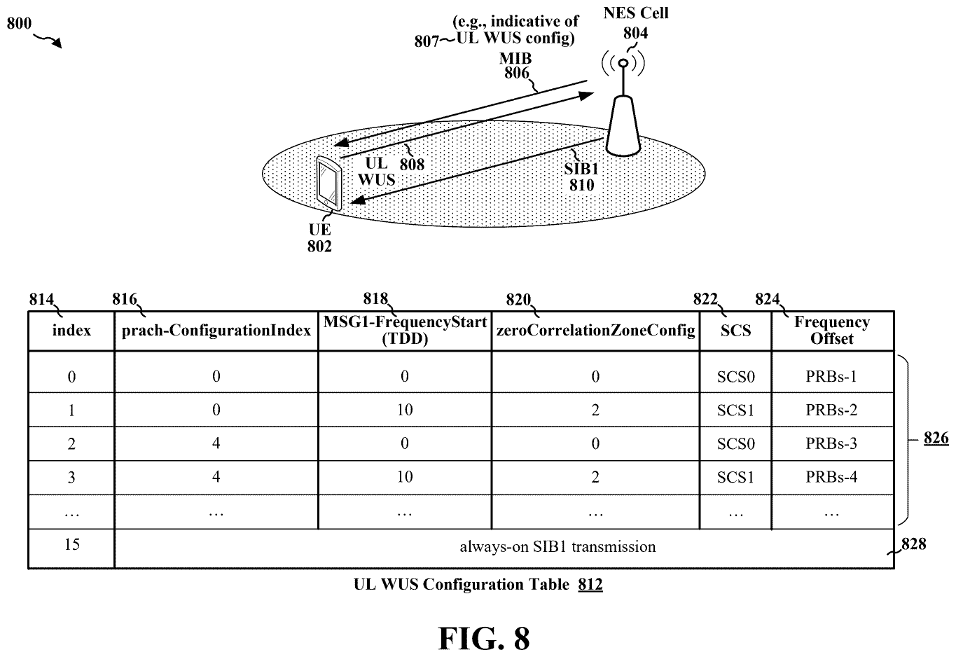

FIG. 8 is a diagram 800 illustrating an UL WUS configuration for standalone OD-SIB1 configurations, in various aspects. Diagram 800 may be an aspect of the call flow diagram 700 in FIG. 7, and illustrates an UL WUS configuration 807 in the context of an UL WUS configuration table 812, a UE 802 and NES cell 804.

For example, the UE 802 may be configured to receive a MIB 806 from the NES cell 804. The MIB 806 may be indicative of the UL WUS configuration 807. The UE 802 may be configured to transmit/provide, for the NES cell 804, an UL WUS 808 based on the UL WUS configuration 807 indicated by the MIB 806, and to receive a SIB1 810 from the NES cell 804, as similarly described herein.

Regarding OD-SIB1 cell configuration (e.g., the UL WUS configuration 807) for the UE 802 and the NES cell 804, in the MIB 806, the MIB 806 may provide a UL WUS-Config field to indicate the UL WUS configuration 807. In aspects, the UL WUS-Config field may be an index 814 into a specification-defined table (e.g., the UL WUS configuration table 812) for the UL WUS configuration 807. In such aspects, one codepoint of the UL WUS-Config field may be associated with the UL WUS configuration 807 of the cell (e.g., the NES cell 804). The UL WUS configuration table 812 may include a set of configurations comprising a set of OD-SIB1 configurations 826 and an always-on SIB1 configuration 828.

The UL WUS configuration table 812 may include, without limitations, parameters for the index 814, a PRACH configuration index 816, a MSG1 frequency start 818 (MSG1-FrequencyStart 818) (e.g., for TDD, may be in PRBs), a zero-correlation zone configuration 820, an SCS 822, a frequency offset 824 for the SSB (e.g., which may be in PRBs (PRBs-1, PRBs-2, PRBs-3, PRBs-4, etc., such as but without limitation, 0 PRBs, 4 PRBs, 8 PRBs, etc.), and/or the like. In aspects, the UL WUS configuration table 812 may include any number of parameters from the generic parameters 504 in FIG. 5, including the PRACH configuration index 506. The UL WUS configuration table 812 may be any type of data structure, according to aspects, and is illustrated in a table format for illustrative and descriptive purposes.

In various aspects, some parameters for the UL WUS configuration 807 may be pre-determined by definition, e.g., in a specification. For instance, parameters for MSG1 frequency division multiplexing (FDM) (e.g., MSG1-FDM), a number of PRACH preambles, power control parameters, a RAR window size, etc., may be pre-defined, and various parameters, e.g., a root sequence index, may be derived from a PCI (e.g., prach-RootSequenceIndex-NIDcell=(prach-RootSequenceIndex+NIDcell) % L_{RA}, where NIDcell is a network identifier of the cell and L_{RA} is the length of the preamble).

Accordingly, the UE 802 may be configured to provide the UL WUS 808 and receive the SIB1 810 based on the UL WUS configuration 807 indicated by the MIB 806.

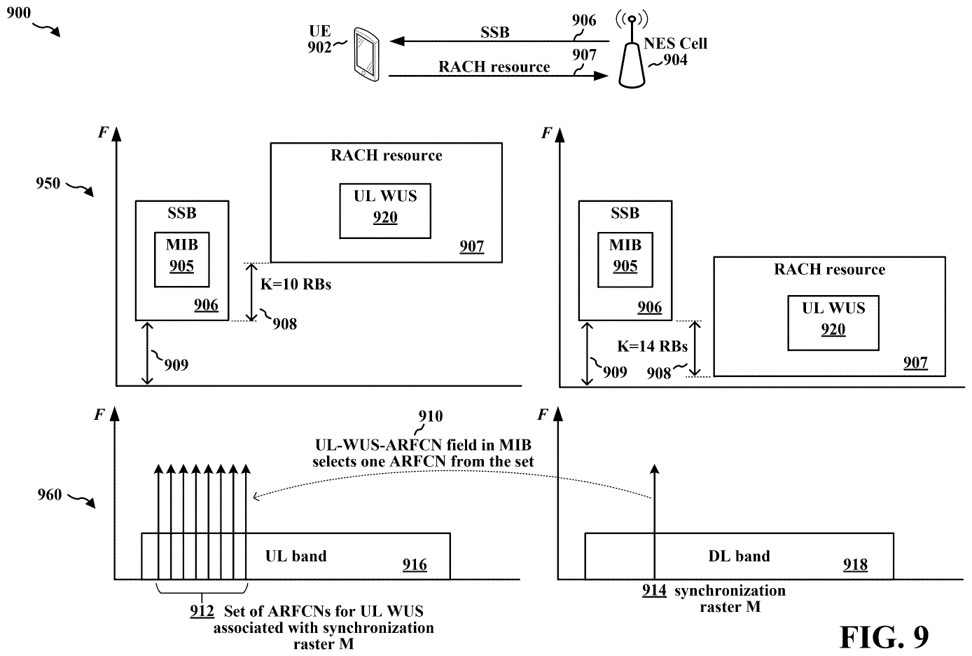

FIG. 9 is a diagram 900 illustrating frequency domain resource indications for standalone OD-SIB1 configurations, in various aspects. Diagram 900 shows a MIB 905 of a SSB 906 for configurations of frequency domain resource indications of a RACH resource 907 for an UL WUS 920 in the context of communications between a UE 902 and a NES cell 904.

In a configuration 950, TDD frequency domain resource indication is shown. In some aspects, the initial UL BWP of TDD frequency domain resource may the same as the initial DL BWP, and the RO may start from the first RO of the initial UL BWP. In other aspects, a RACH frequency offset 908 (e.g., the MSG1-FrequencyStart 818 of the UL WUS configuration table 812 in FIG. 8) may indicate a PRB offset of the RACH resource relative to lowest PRB associated with the SSB 906. For example, the SSB 906 may include the MIB 905 and may have an SSB frequency offset 909, as noted above in the UL WUS configuration table 812 in FIG. 8 (e.g., the frequency offset 824). Transmission of the MIB 905 may be followed by transmission of a RACH resource 907. The RACH resource 907 may be offset in frequency from the SSB 906 based on a RACH frequency offset 908. In aspects, the RACH frequency offset 908 may have a value ‘K’ that indicates a number of PRBs comprising the offset.

In a configuration 960, FDD frequency domain resource indication is shown. As one example, an UL band 916 and a DL band 918 are shown. In the UL band 916, a set of ARFCNs 912 is present for UL WUS associated with a synchronization raster point 914, of a set of synchronization raster points, in the DL band 918. For each synchronization raster point (e.g., the synchronization raster point 914), a set of candidate ARFCNs for UL WUS (e.g., the set of ARFCNs 912) may be defined. The MIB 905 may include a separate field 910 (e.g., UL WUS-ARFCN) to indicate one ARFCN from the set of ARFCNs 912, as candidates, for utilization. The ARFCN selected from the set of ARFCNs 912 for the UL WUS may be associated with a first tone of the RACH resource 907 in the frequency domain, according to aspects.

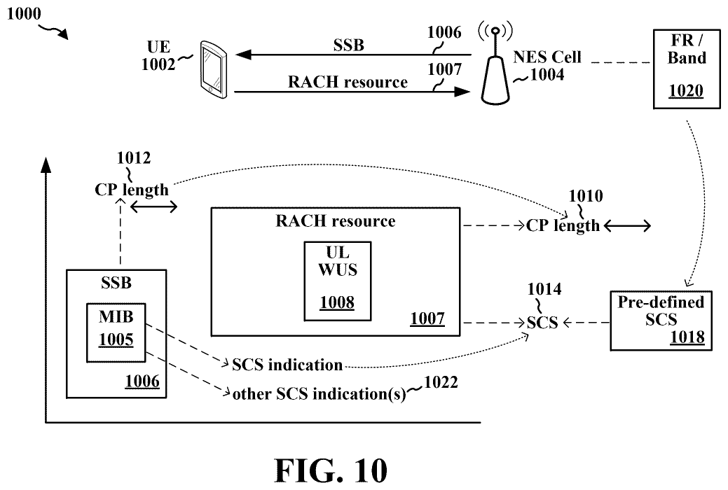

FIG. 10 is a diagram 1000 illustrating CP and SCS indications for standalone OD-SIB1 configurations, in various aspects. Diagram 1000 shows a MIB 1005 of an SSB 1006 for configurations of CP and SCS indications of a RACH resource 1007 for an UL WUS 1008 in the context of communications between a UE 1002 and a NES cell 1004.

Regarding CP indications, a CP length 1010 for an UL BWP to determine the RACH resource 1007 may be the same as a CP length 1012 of the SSB 1006, in aspects. That is, the CP length 1010, associated with a determination of the RACH resource 1007, for an UL BWP of the UL WUS 1008, may be based on the SSB CP length (e.g., the CP length 1010) of the SSB 1006 that comprises the MIB 1005.

Regarding SCS indications, an SCS 1014 for the RACH resource 1007 may be a pre-determined SCS or a pre-defined SCS 1018, e.g., via a standard/specification, as a function of an FR or band 1020, in some aspects. In other aspects, the SCS 1014 may be indicated in the UL WUS configuration table (e.g., the UL WUS configuration table 812 in FIG. 8, via a column thereof based on the index 814 indication of the UL WUS configuration 807), and candidate PRACH SCSs (e.g., shown as the set of SCSs in the SCS 822 column of the UL WUS configuration table 812 in FIG. 8) may be pre-determined in the standard/specification as a function of the FR or band 1020.

In some aspects, other SCSs 1022 for other UL channels/signals (e.g., PUCCH, etc., that are not the PRACH) of the UL BWP, may be the same as the SCS of the SSB 1006 or the SCS of the initial DL BWP. In other aspects, the other SCSs 1022 for the other UL channels/signals may be indicated via separate field in the MIB 1005 where the candidate SCSs may again be pre-determined as a function of the FR or band 1020. In some aspects, a PUCCH may be transmitted for a HARQ-ACK of a MSG2 PDSCH before SIB1 decoding.

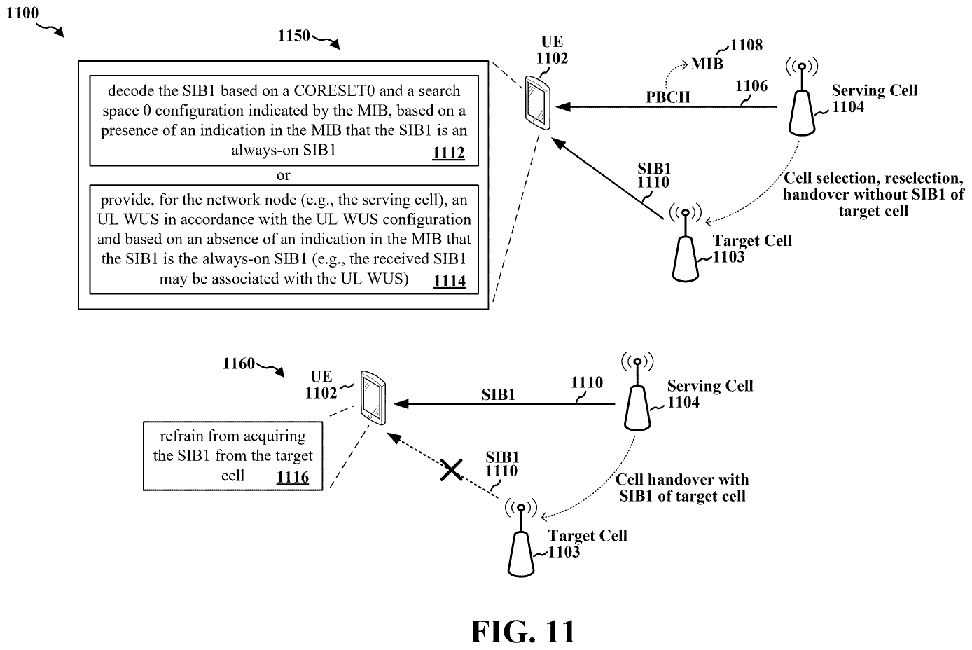

FIG. 11 is a diagram 1100 illustrating cell selections and handovers for standalone OD-SIB1 configurations, in various aspects. Diagram 1100 shows a MIB 1108 that may indicate properties of a SIB1 for configurations in the context of communications for selection, reselection, and/or handover of a UE 1102 from a NES cell 1104 (e.g., a source cell) to a NES cell 1103 (e.g., a target cell).

In a configuration 1150, during cell selection/reselection or a handover procedure (e.g., including a conditional handover), the UE 1102 may be configured to receive, and the NES cell 1104 may be configured to transmit/provide, a PBCH 1106 that includes the MIB 1108. The UE 1102 may be configured to decode the PBCH 1106 that is received to acquire/obtain the MIB 1108. In aspects, the MIB 1108 may include an indication of a UL WUS configuration, as described herein, e.g., via a field in the MIB 1108.

During cell selection/reselection or a handover procedure, if the UL WUS configuration indication/field in the MIB 1108 indicates an always-on SIB1 transmission, the UE 1102 may be configured to decode (e.g., at 1112) the SIB1 1110 according to a {CORESET0, SearchSpace0} configuration indicated in the MIB 1108. As an example, based on a presence of an indication in the MIB 1108 that the SIB1 1110 provided/transmitted by the NES cell 1103 (e.g., the target cell), and received by the UE 1102, is an always-on SIB1, the UE 1102 may be configured to decode (e.g., at 1112) the SIB1 1110 based on a CORESET0 and a search space 0 configuration indicated by the MIB 1108.

In the configuration 1150, during cell selection/reselection, if the UL WUS configuration indication/field in the MIB 1108 does not indicate an always-on SIB1 transmission, the UE 1102 may be configured to obtain the UL WUS configuration indication and initiate an on-demand SIB1 procedure to acquire the SIB1 1110 by transmitting an UL WUS. As an example, the UE 1102 may be configured to provide (e.g., at 1114), for the NES cell 1104 (e.g., the source cell), an UL WUS in accordance with the UL WUS configuration and based on an absence of an indication in the MIB 1108 that the SIB1 1110 is an always-on SIB1 (e.g., the received SIB1 1110 may be associated with the UL WUS).

In a configuration 1160, during a handover (including a conditional handover), the UE 1102 may be configured to receive, and the NES cell 1104 (e.g., the source cell) may be configured to transmit/provide, the SIB1 1110. For instance, the NES cell 1104 may have the SIB1 1110 for the NES cell 1103 (e.g., the target cell) for provision to the UE 1102. Accordingly, the UE 1102 may be configured to refrain (e.g., at 1116) from acquiring the SIB1 1110 from the NES cell 1103 (e.g., the target cell).

In aspects, the NES cell 1004 (e.g., the source cell) may not provide any information regarding OD-SIB1 operations of neighbor cells (e.g., the NES cell 1103 as the target cell).

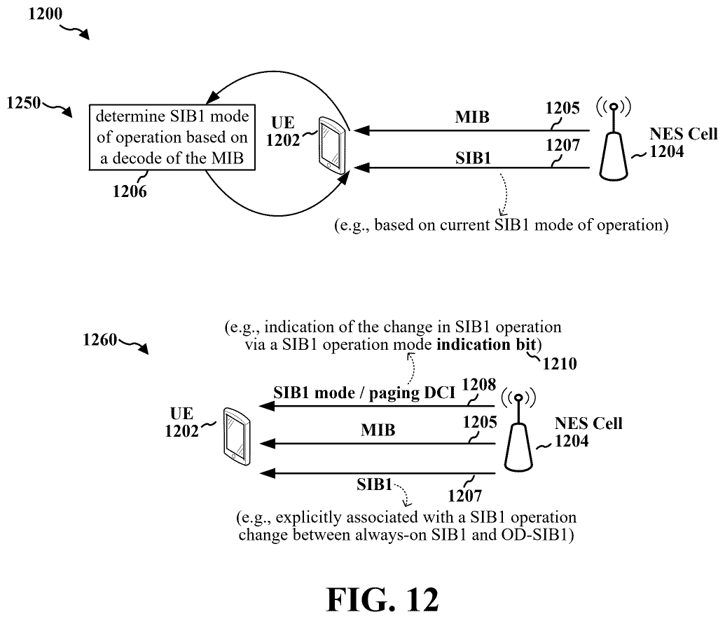

FIG. 12 is a diagram 1200 illustrating switching between always-on SIB1 and OD-SIB1 for standalone OD-SIB1 configurations, in various aspects. Diagram 1200 shows a MIB 1205 that may indicate properties of a SIB1 1207 for configurations in the context of communications between a UE 1202 from a NES cell 1204.

In aspects, a network that includes the NES cell 1204 may switch between always-on SIB1 and OD-SIB1 operation for the NES cell 1204, e.g., depending on network loading, etc. The NES cell 1204 may be configured to change an UL WUS configuration indication according to always-on SIB1 and OD-SIB1 operations. In aspects, an indication of a SIB1 operation modification for the SIB1 1207 may be obtained by the UE 1202. In aspects, the UE 1202 may be in an RRC idle/inactive state or in an RRC connected state.

In a configuration 1250, the NES cell 1204 may not provide an explicit indication of switching between always-on SIB1 and OD-SIB1 operations to the UE 1202 in the NES cell 1204. Rather, the UE 1202 may be configured to determine the SIB1 operation mode for the NES cell 1204 based implicitly on communications. In some aspects, an SI update procedure initiated by the network may be triggered by paging, and in such configurations, the NES cell 1204 may transmits the SIB1 1207. For UE-autonomous SIB1 acquisition/re-acquisition aspects, e.g., for the UE 1202 and the SIB1 1207, the UE 1202 may be configured to receive a MIB 1205 from the NES cell 1204. The UE 1202 may be configured to determine (e.g., at 1206) the mode of operation for the SIB1 1207 based on a decode of the MIB 1205 (e.g., the UE 1202 determines the current SIB1 transmission mode for the NES cell 1204). The UE 1202 may further receive the SIB1 1207 based on the current mode of operation for the SIB1 1207 that is determined (e.g., at 1206).

In some aspects, such as for a configuration 1260, the network may be configured to transmit/provide, via the NES cell 1204 and to the UE 1202 in the NES cell 1204, an explicit indication of switching between always-on SIB1 and OD-SIB1 operation. The indication may be transmitted/provided by the NES cell 1204, and received by the UE 1202, via an SI modification of SIB1 mode/paging DCI 1208 (e.g., a SIB1 operation mode for an indication bit 1210) or in paging DCI of SIB1 mode/paging DCI 1208 (e.g., a separate indication for the indication bit 1210). Upon receiving the indication bit 1210, the UE 1202 may be configured to skip MIB 1205 decoding to determine the current SIB1 transmission mode for the NES cell 1204, and then receive the SIB1 1207.

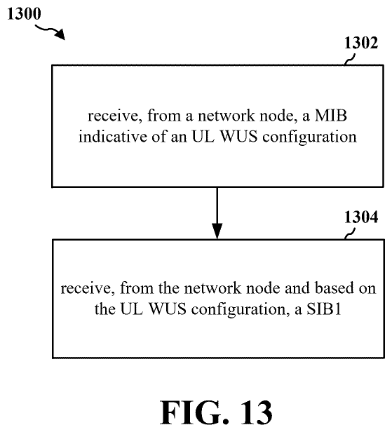

FIG. 13 is a flowchart 1300 of a method of wireless communication. The method may be performed by a UE (e.g., the UE 104, 702, 802, 902, 1002, 1102, 1202; the apparatus 1504). The method may be for standalone OD-SIB1 configurations. The method may enable support of standalone OD-SIB1 operations with a cell on which the UE camps, e.g., a NES cell where the UE is in an idle/inactive state, and without an anchor cell, and may enable bypassing communications with an anchor cell and reducing UE cell switching by providing the UL WUS configuration from an OD-SIB1 cell, and also reducing backhaul coordination and SIB signaling overhead by providing the UL WUS configuration in a MIB from an OD-SIB1 cell.

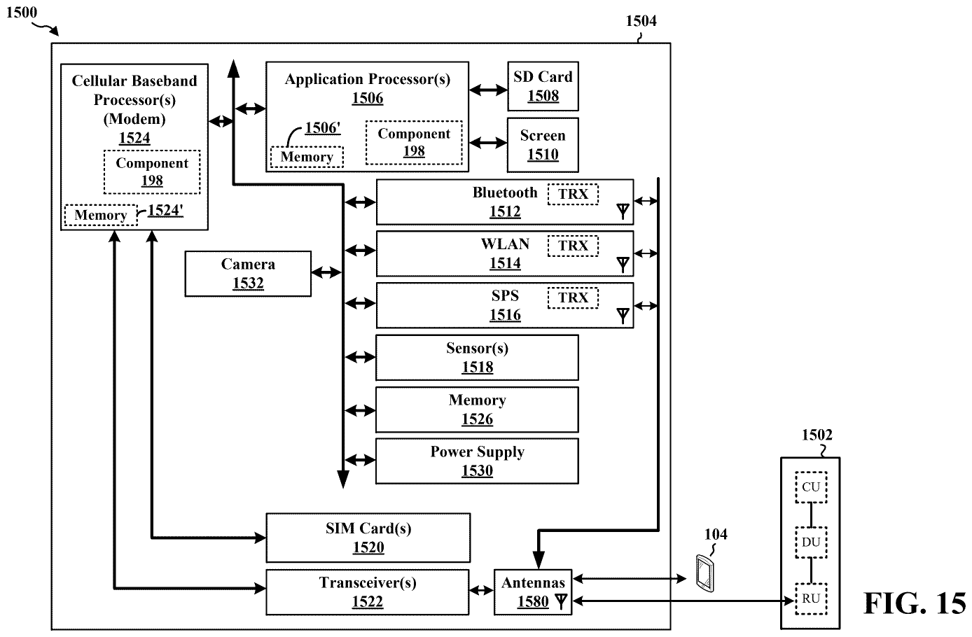

At 1302, the UE receives, from a network node, a MIB indicative of an UL WUS configuration. As an example, the reception may be performed by one or more of the component 198, the transceiver(s) 1522, and/or the antennas 1580 in FIG. 15. FIG. 7 illustrates, in the context of FIGS. 8, 9, 10, 11, 12 an example of the UE 702 receiving such a MIB from a network node (e.g., the base station 704 (e.g., as a NES cell)).

The UE 702 may be configured to receive, and the base station 704 may be configured to transmit/provide, a MIB 706 (e.g., 806 in FIG. 8; 905 in FIG. 9; 1005 in FIG. 10; 1108 in FIG. 11; 1205 in FIG. 12) indicative of an UL WUS configuration 707 (e.g., 807 in FIG. 8; 910 in FIG. 9). In aspects, an SSB (e.g., 906 in FIG. 9; 1006 in FIG. 10) may comprise the MIB 706 (e.g., 806 in FIG. 8; 905 in FIG. 9; 1005 in FIG. 10; 1108 in FIG. 11; 1205 in FIG. 12). In such aspects, the UL WUS configuration 707 (e.g., 807 in FIG. 8; 910 in FIG. 9) may be associated with a configuration index (e.g., 814 in FIG. 8) for a set of UL WUS configurations (e.g., 812 in FIG. 8), and a single codepoint of the MIB 706 (e.g., 806 in FIG. 8; 905 in FIG. 9; 1005 in FIG. 10; 1108 in FIG. 11; 1205 in FIG. 12) and associated with the UL WUS configuration 707 (e.g., 807 in FIG. 8; 910 in FIG. 9). The UL WUS configuration 707 (e.g., 807 in FIG. 8; 910 in FIG. 9) may be associated with a configuration for at least one of a message type 1 (MSG1) frequency start offset (e.g., 818 in FIG. 8; 909 in FIG. 9), a number of PRACH preambles, a PRACH configuration index (e.g., 816 in FIG. 8), a zero correlation zone configuration (e.g., 820 in FIG. 8), a power control parameter, a random access response (RAR) window size, a PRACH SCS (e.g., 822 in FIG. 8), a non-PRACH SCS (e.g., 822 in FIG. 8), a set of absolute radio-frequency channel numbers (ARFCNs) (e.g., 912 in FIG. 9) associated with a set of synchronization raster points (e.g., 914 in FIG. 9), a frequency offset (e.g., 824 in FIG. 8; 908 in FIG. 9), and/or the like, as described in further detail herein. The SCS (e.g., 822 in FIG. 8; 1014 in FIG. 10) of a PRACH may be based on a pre-defined SCS (e.g., 1018 in FIG. 10) associated with a frequency range or a band of the network node (e.g., the base station 704), while in other examples, the SCS (e.g., 822 in FIG. 8; 1014 in FIG. 10) of a PRACH may be based on the PRACH SCS among a set of PRACH SCSs associated with the frequency range or the band of the network node (e.g., the base station 704). In such aspects, the MIB 706 (e.g., 806 in FIG. 8; 905 in FIG. 9; 1005 in FIG. 10; 1108 in FIG. 11; 1205 in FIG. 12) may be indicative of the PRACH SCS among the set of PRACH SCSs. In some aspects, an SCS (e.g., 822 in FIG. 8; 1014 in FIG. 10) of an UL channel other than a PRACH may be based on a first SCS (e.g., 1014 in FIG. 10) of an SSB (e.g., 906 in FIG. 9; 1006 in FIG. 10) that comprises the MIB 706 (e.g., 806 in FIG. 8; 905 in FIG. 9; 1005 in FIG. 10; 1108 in FIG. 11; 1205 in FIG. 12) or a second SCS of an initial DL BWP associated with the MIB 706 (e.g., 806 in FIG. 8; 905 in FIG. 9; 1005 in FIG. 10; 1108 in FIG. 11; 1205 in FIG. 12). In some aspects, the SCS of an UL channel other than a PRACH may be based on the non-PRACH SCS (e.g., 1022 in FIG. 10) among a set of non-PRACH SCSs associated with a frequency range or a band of the network node (e.g., the base station 704) (e.g., where the MIB 706 (e.g., 806 in FIG. 8; 905 in FIG. 9; 1005 in FIG. 10; 1108 in FIG. 11; 1205 in FIG. 12) is indicative of the non-PRACH SCS (e.g., 1022 in FIG. 10) among the set of non-PRACH SCSs). To receive the MIB 706 (e.g., 806 in FIG. 8; 905 in FIG. 9; 1005 in FIG. 10; 1108 in FIG. 11; 1205 in FIG. 12), the UE 702 may be configured to receive, from the network node (e.g., the base station 704), a PBCH (e.g., 1106 in FIG. 11) during a cell selection, a cell reselection, or a handover procedure in which a provision of the SIB1 710 (e.g., 810 in FIG. 8; 1110 in FIG. 11; 1207 in FIG. 12) for a target cell from a source cell (e.g., the network node (e.g., the base station 704)) is absent. In such aspects, to receive the SIB1 710 (e.g., 810 in FIG. 8; 1110 in FIG. 11; 1207 in FIG. 12), the UE 702 may be configured to receive the SIB1 710 (e.g., 810 in FIG. 8; 1110 in FIG. 11; 1207 in FIG. 12) from the target cell based on a decode (e.g., at 1112 in FIG. 11) of the PBCH (e.g., 1106 in FIG. 11). In aspects, the MIB 706 (e.g., 806 in FIG. 8; 905 in FIG. 9; 1005 in FIG. 10; 1108 in FIG. 11; 1205 in FIG. 12) may be indicative of an always-on SIB1 transmission configuration (e.g., for the SIB1 710 (e.g., 810 in FIG. 8; 1110 in FIG. 11; 1207 in FIG. 12)).

The UE 702 may be configured to transmit/provide, and the base station 704 may be configured to receive, an UL WUS 708 (e.g., 808 in FIG. 8; 920 in FIG. 9; 1008 in FIG. 10) in accordance with the UL WUS configuration 707 (e.g., 807 in FIG. 8; 910 in FIG. 9) (e.g., indicated by the MIB 706 (e.g., 806 in FIG. 8; 905 in FIG. 9; 1005 in FIG. 10; 1108 in FIG. 11; 1205 in FIG. 12)). In some aspects, a TDD frequency domain resource for an UL BWP of the UL WUS 708 (e.g., 808 in FIG. 8; 920 in FIG. 9; 1008 in FIG. 10) may be based on the MSG1 frequency start offset relative to a lowest PRB associated with an SSB (e.g., 906 in FIG. 9; 1006 in FIG. 10) that comprises the MIB 706 (e.g., 806 in FIG. 8; 905 in FIG. 9; 1005 in FIG. 10; 1108 in FIG. 11; 1205 in FIG. 12). In such aspects, the MIB (e.g., 705 in FIG. 7; 806 in FIG. 8; 905 in FIG. 9; 1005 in FIG. 10; 1108 in FIG. 11; 1205 in FIG. 12) may be indicative of the MSG1 frequency start offset (e.g., 818 in FIG. 8; 909 in FIG. 9). In some aspects, an FDD frequency domain resource (e.g., 960 in FIG. 9) of the UL WUS 708 (e.g., 808 in FIG. 8; 920 in FIG. 9; 1008 in FIG. 10) is based on an ARFCN, of the set of ARFCNs (e.g., 912 in FIG. 9), associated with a first tone of a RACH resource (e.g., 907 in FIG. 9; 1007 in FIG. 10) in the frequency domain. In such aspects, the MIB 706 (e.g., 806 in FIG. 8; 905 in FIG. 9; 1005 in FIG. 10; 1108 in FIG. 11; 1205 in FIG. 12) may be indicative of the ARFCN. In aspects, the UE 702 may be configured to transmit/provide (e.g., at 1114 in FIG. 11), and the network node (e.g., the base station 704) may be configured to receive, the UL WUS 708 (e.g., 808 in FIG. 8; 920 in FIG. 9; 1008 in FIG. 10) in accordance with the UL WUS configuration 707 (e.g., 807 in FIG. 8; 910 in FIG. 9) and based on an absence of an indication in the MIB 706 (e.g., 806 in FIG. 8; 905 in FIG. 9; 1005 in FIG. 10; 1108 in FIG. 11; 1205 in FIG. 12) that the SIB1 710 (e.g., 810 in FIG. 8; 1110 in FIG. 11; 1207 in FIG. 12) is an always-on SIB1. In such aspects, the received SIB1 (e.g., the SIB1 710 (e.g., 810 in FIG. 8; 1110 in FIG. 11; 1207 in FIG. 12)) may be associated with the UL WUS 708 (e.g., 808 in FIG. 8; 920 in FIG. 9; 1008 in FIG. 10). In aspects, a TDD frequency domain resource (e.g., 950 in FIG. 9) for an UL BWP of the UL WUS 708 (e.g., 808 in FIG. 8; 920 in FIG. 9; 1008 in FIG. 10) may be based on an initial DL BWP associated with the MIB 706 (e.g., 806 in FIG. 8; 905 in FIG. 9; 1005 in FIG. 10; 1108 in FIG. 11; 1205 in FIG. 12). In such aspects, a RACH occasion (RO) for the UL WUS 708 (e.g., 808 in FIG. 8; 920 in FIG. 9; 1008 in FIG. 10) may be an initial RO of an initial UL BWP. In aspects, a CP length (e.g., 1010 in FIG. 10), associated with a determination of a RACH resource (e.g., 907 in FIG. 9; 1007 in FIG. 10), for an UL BWP of the UL WUS 708 (e.g., 808 in FIG. 8; 920 in FIG. 9; 1008 in FIG. 10) may be based on an SSB CP length (e.g., 1012 in FIG. 10) of an SSB (e.g., 906 in FIG. 9; 1006 in FIG. 10) that comprises the MIB 706 (e.g., 806 in FIG. 8; 905 in FIG. 9; 1005 in FIG. 10; 1108 in FIG. 11; 1205 in FIG. 12).

At 1304, the UE receives, from the network node and based on the UL WUS configuration, a SIB1. As an example, the reception may be performed by one or more of the component 198, the transceiver(s) 1522, and/or the antennas 1580 in FIG. 15. FIG. 7 illustrates, in the context of FIGS. 8, 9, 10, 11, 12 an example of the UE 702 receiving such a SIB1 from a network node (e.g., the base station 704 (e.g., as a NES cell)).

The UE 702 may be configured to receive, and the network node (e.g., the base station 704) may be configured to transmit/provide, a SIB1 710 (e.g., 810 in FIG. 8; 1110 in FIG. 11; 1207 in FIG. 12). In aspects, the SIB1 710 (e.g., 810 in FIG. 8; 1110 in FIG. 11; 1207 in FIG. 12) may be based on the UL WUS configuration 707 (e.g., 807 in FIG. 8; 910 in FIG. 9), and the SIB1 710 (e.g., 810 in FIG. 8; 1110 in FIG. 11; 1207 in FIG. 12) that is received may be associated with the UL WUS 708 (e.g., 808 in FIG. 8; 920 in FIG. 9; 1008 in FIG. 10). In aspects, to receive the SIB1 710 (e.g., 810 in FIG. 8; 1110 in FIG. 11; 1207 in FIG. 12), the UE 702 may be configured to decode (e.g., at 1112 in FIG. 11) the SIB1 710 (e.g., 810 in FIG. 8; 1110 in FIG. 11; 1207 in FIG. 12) based on a control resource set 0 (CORESET0) and a search space 0 configuration indicated by the MIB 706 (e.g., 806 in FIG. 8; 905 in FIG. 9; 1005 in FIG. 10; 1108 in FIG. 11; 1205 in FIG. 12) based on a presence of an indication in the MIB 706 (e.g., 806 in FIG. 8; 905 in FIG. 9; 1005 in FIG. 10; 1108 in FIG. 11; 1205 in FIG. 12) that the SIB1 710 (e.g., 810 in FIG. 8; 1110 in FIG. 11; 1207 in FIG. 12) is an always-on SIB1 (e.g., via 814, 828 in FIG. 8). In aspects, to receive the SIB1 710 (e.g., 810 in FIG. 8; 1110 in FIG. 11; 1207 in FIG. 12), the UE 702 may be configured to receive the SIB1 710 (e.g., 810 in FIG. 8; 1110 in FIG. 11; 1207 in FIG. 12) from a source cell (e.g., the network node (e.g., the base station 704)) during a handover procedure. Is such aspects, the UE 702 may be configured to refrain (e.g., at 1116 in FIG. 11) from acquiring the SIB1 710 (e.g., 810 in FIG. 8; 1110 in FIG. 11; 1207 in FIG. 12) from a target cell. In some aspects, the SIB1 710 (e.g., 810 in FIG. 8; 1110 in FIG. 11; 1207 in FIG. 12) may be associated with a change in SIB1 operation between an always-on SIB1 (e.g., 828 in FIG. 8) and an on-demand SIB1 (e.g., 826 in FIG. 8), where the change in SIB1 operation may be based on an implicit indication(s) in communications. In aspects, an implicit indication may provide for the UE 702 to be configured to decode a PBCH (e.g., 1106 in FIG. 11) to re-obtain an UL WUS configuration (e.g., 707 in FIG. 7; 807 in FIG. 8; 910 in FIG. 9) and to then determine a SIB1 transmission mode. For example, the UE 702, to receive, as transmitted/provided by the base station 704, and based on the UL WUS configuration 707 (e.g., 807 in FIG. 8; 910 in FIG. 9), the SIB1 710 (e.g., 810 in FIG. 8; 1110 in FIG. 11; 1207 in FIG. 12), may be configured to determine (e.g., at 1206 in FIG. 12) a current SIB1 operation mode associated with the network node (e.g., the base station 704) based on decoding the MIB 706 (e.g., 806 in FIG. 8; 905 in FIG. 9; 1005 in FIG. 10; 1108 in FIG. 11; 1205 in FIG. 12), and to receive, from the network node (e.g., the base station 704), the SIB1 710 (e.g., 810 in FIG. 8; 1110 in FIG. 11; 1207 in FIG. 12) based on the current SIB1 operation mode. In some aspects, the SIB1 710 (e.g., 810 in FIG. 8; 1110 in FIG. 11; 1207 in FIG. 12) may be associated with a change in SIB1 operation between an always-on SIB1 (e.g., 826 in FIG. 8) and an on-demand SIB1 (e.g., 828 in FIG. 8), where the change in SIB1 operation is based on an explicit indication(s) in communications. In aspects, an explicit indication may provide for the UE 702 to be configured to determine a SIB1 transmission mode (e.g., always-on SIB1 (e.g., 826 in FIG. 8) or OD-SIB1 (e.g., 828 in FIG. 8)) based on a bit in paging DCI (e.g., 1208 in FIG. 12). In this case, UE may not decode the PBCH (e.g., 1106 in FIG. 11). For example, the UE 702, to receive, as transmitted/provided by the base station 704, and based on the UL WUS configuration 707 (e.g., 807 in FIG. 8; 910 in FIG. 9), the SIB1 710 (e.g., 810 in FIG. 8; 1110 in FIG. 11; 1207 in FIG. 12), may be configured to receive, from the network node (e.g., the base station 704), an indication of the change in SIB1 operation mode via a SIB1 operation mode indication bit in paging DCI (e.g., 1208 in FIG. 12).

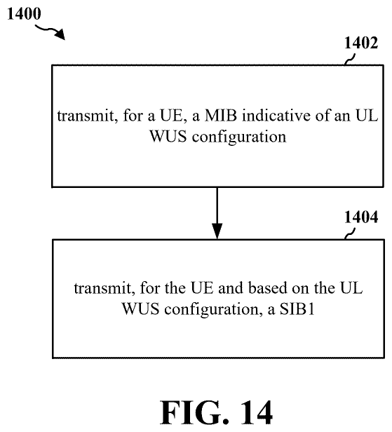

FIG. 14 is a flowchart 1400 of a method of wireless communication. The method may be performed a network node, a base station, a gNB, etc., as a NES cell (e.g., the base station 102, 704; the NES cell 804, 904, 1004, 1104, 1204; the network entity 1502, 1602). The method may be for standalone OD-SIB1 configurations. The method may enable support of standalone OD-SIB1 operations with a cell on which the UE camps, e.g., a NES cell where the UE is in an idle/inactive state, and without an anchor cell, and may enable bypassing communications with an anchor cell and reducing UE cell switching by providing the UL WUS configuration from an OD-SIB1 cell, and also reducing backhaul coordination and SIB signaling overhead by providing the UL WUS configuration in a MIB from an OD-SIB1 cell.

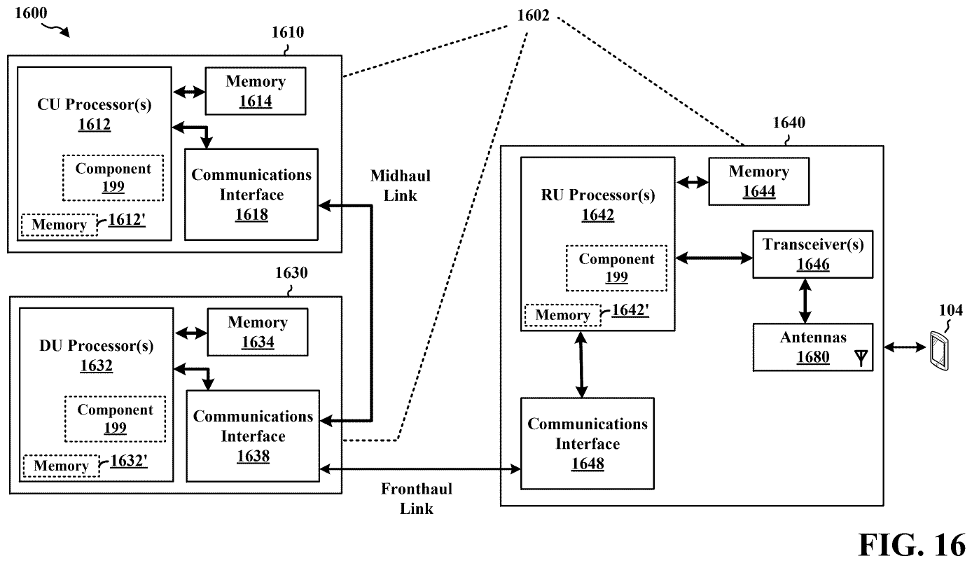

At 1402, the network node provides/transmits, for a UE, a MIB indicative of an UL WUS configuration. As an example, the provision/transmission may be performed by one or more of the component 199, the transceiver(s) 1646, and/or the antennas 1680 in FIG. 16. FIG. 7 illustrates, in the context of FIGS. 8, 9, 10, 11, 12 an example of the base station 704 (e.g., as a NES cell) providing/transmitting such a MIB for a UE (e.g., the UE 702).

The base station 704 may be configured to transmit/provide, and the UE 702 may be configured to receive, a MIB 706 (e.g., 806 in FIG. 8; 905 in FIG. 9; 1005 in FIG. 10; 1108 in FIG. 11; 1205 in FIG. 12) indicative of an UL WUS configuration 707 (e.g., 807 in FIG. 8; 910 in FIG. 9). In aspects, an SSB (e.g., 906 in FIG. 9; 1006 in FIG. 10) may comprise the MIB 706 (e.g., 806 in FIG. 8; 905 in FIG. 9; 1005 in FIG. 10; 1108 in FIG. 11; 1205 in FIG. 12). In such aspects, the UL WUS configuration 707 (e.g., 807 in FIG. 8; 910 in FIG. 9) may be associated with a configuration index (e.g., 814 in FIG. 8) for a set of UL WUS configurations (e.g., 812 in FIG. 8), and a single codepoint of the MIB 706 (e.g., 806 in FIG. 8; 905 in FIG. 9; 1005 in FIG. 10; 1108 in FIG. 11; 1205 in FIG. 12) and associated with the UL WUS configuration 707 (e.g., 807 in FIG. 8; 910 in FIG. 9). The UL WUS configuration 707 (e.g., 807 in FIG. 8; 910 in FIG. 9) may be associated with a configuration for at least one of a message type 1 (MSG1) frequency start offset (e.g., 818 in FIG. 8; 909 in FIG. 9), a number of PRACH preambles, a PRACH configuration index (e.g., 816 in FIG. 8), a zero correlation zone configuration (e.g., 820 in FIG. 8), a power control parameter, a random access response (RAR) window size, a PRACH SCS (e.g., 822 in FIG. 8), a non-PRACH SCS (e.g., 822 in FIG. 8), a set of absolute radio-frequency channel numbers (ARFCNs) (e.g., 912 in FIG. 9) associated with a set of synchronization raster points (e.g., 914 in FIG. 9), a frequency offset (e.g., 824 in FIG. 8; 908 in FIG. 9), and/or the like, as described in further detail herein. The SCS (e.g., 822 in FIG. 8; 1014 in FIG. 10) of a PRACH may be based on a pre-defined SCS (e.g., 1018 in FIG. 10) associated with a frequency range or a band of the network node (e.g., the base station 704), while in other examples, the SCS (e.g., 822 in FIG. 8; 1014 in FIG. 10) of a PRACH may be based on the PRACH SCS among a set of PRACH SCSs associated with the frequency range or the band of the network node (e.g., the base station 704). In such aspects, the MIB 706 (e.g., 806 in FIG. 8; 905 in FIG. 9; 1005 in FIG. 10; 1108 in FIG. 11; 1205 in FIG. 12) may be indicative of the PRACH SCS among the set of PRACH SCSs. In some aspects, an SCS (e.g., 822 in FIG. 8; 1014 in FIG. 10) of an UL channel other than a PRACH may be based on a first SCS (e.g., 1014 in FIG. 10) of an SSB (e.g., 906 in FIG. 9; 1006 in FIG. 10) that comprises the MIB 706 (e.g., 806 in FIG. 8; 905 in FIG. 9; 1005 in FIG. 10; 1108 in FIG. 11; 1205 in FIG. 12) or a second SCS of an initial DL BWP associated with the MIB 706 (e.g., 806 in FIG. 8; 905 in FIG. 9; 1005 in FIG. 10; 1108 in FIG. 11; 1205 in FIG. 12). In some aspects, the SCS of an UL channel other than a PRACH may be based on the non-PRACH SCS (e.g., 1022 in FIG. 10) among a set of non-PRACH SCSs associated with a frequency range or a band of the network node (e.g., the base station 704) (e.g., where the MIB 706 (e.g., 806 in FIG. 8; 905 in FIG. 9; 1005 in FIG. 10; 1108 in FIG. 11; 1205 in FIG. 12) is indicative of the non-PRACH SCS (e.g., 1022 in FIG. 10) among the set of non-PRACH SCSs). To receive the MIB 706 (e.g., 806 in FIG. 8; 905 in FIG. 9; 1005 in FIG. 10; 1108 in FIG. 11; 1205 in FIG. 12), the UE 702 may be configured to receive, from the network node (e.g., the base station 704), a PBCH (e.g., 1106 in FIG. 11) during a cell selection, a cell reselection, or a handover procedure in which a provision of the SIB1 710 (e.g., 810 in FIG. 8; 1110 in FIG. 11; 1207 in FIG. 12) for a target cell from a source cell (e.g., the network node (e.g., the base station 704)) is absent. In such aspects, to receive the SIB1 710 (e.g., 810 in FIG. 8; 1110 in FIG. 11; 1207 in FIG. 12), the UE 702 may be configured to receive the SIB1 710 (e.g., 810 in FIG. 8; 1110 in FIG. 11; 1207 in FIG. 12) from the target cell based on a decode (e.g., at 1112 in FIG. 11) of the PBCH (e.g., 1106 in FIG. 11). In aspects, the MIB 706 (e.g., 806 in FIG. 8; 905 in FIG. 9; 1005 in FIG. 10; 1108 in FIG. 11; 1205 in FIG. 12) may be indicative of an always-on SIB1 transmission configuration (e.g., for the SIB1 710 (e.g., 810 in FIG. 8; 1110 in FIG. 11; 1207 in FIG. 12)).

The UE 702 may be configured to transmit/provide, and the base station 704 may be configured to receive, an UL WUS 708 (e.g., 808 in FIG. 8; 920 in FIG. 9; 1008 in FIG. 10) in accordance with the UL WUS configuration 707 (e.g., 807 in FIG. 8; 910 in FIG. 9) (e.g., indicated by the MIB 706 (e.g., 806 in FIG. 8; 905 in FIG. 9; 1005 in FIG. 10; 1108 in FIG. 11; 1205 in FIG. 12)). In some aspects, a TDD frequency domain resource for an UL BWP of the UL WUS 708 (e.g., 808 in FIG. 8; 920 in FIG. 9; 1008 in FIG. 10) may be based on the MSG1 frequency start offset relative to a lowest PRB associated with an SSB (e.g., 906 in FIG. 9; 1006 in FIG. 10) that comprises the MIB 706 (e.g., 806 in FIG. 8; 905 in FIG. 9; 1005 in FIG. 10; 1108 in FIG. 11; 1205 in FIG. 12). In such aspects, the MIB (e.g., 705 in FIG. 7; 806 in FIG. 8; 905 in FIG. 9; 1005 in FIG. 10; 1108 in FIG. 11; 1205 in FIG. 12) may be indicative of the MSG1 frequency start offset (e.g., 818 in FIG. 8; 909 in FIG. 9). In some aspects, an FDD frequency domain resource (e.g., 960 in FIG. 9) of the UL WUS 708 (e.g., 808 in FIG. 8; 920 in FIG. 9; 1008 in FIG. 10) is based on an ARFCN, of the set of ARFCNs (e.g., 912 in FIG. 9), associated with a first tone of a RACH resource (e.g., 907 in FIG. 9; 1007 in FIG. 10) in the frequency domain. In such aspects, the MIB 706 (e.g., 806 in FIG. 8; 905 in FIG. 9; 1005 in FIG. 10; 1108 in FIG. 11; 1205 in FIG. 12) may be indicative of the ARFCN. In aspects, the UE 702 may be configured to transmit/provide (e.g., at 1114 in FIG. 11), and the network node (e.g., the base station 704) may be configured to receive, the UL WUS 708 (e.g., 808 in FIG. 8; 920 in FIG. 9; 1008 in FIG. 10) in accordance with the UL WUS configuration 707 (e.g., 807 in FIG. 8; 910 in FIG. 9) and based on an absence of an indication in the MIB 706 (e.g., 806 in FIG. 8; 905 in FIG. 9; 1005 in FIG. 10; 1108 in FIG. 11; 1205 in FIG. 12) that the SIB1 710 (e.g., 810 in FIG. 8; 1110 in FIG. 11; 1207 in FIG. 12) is an always-on SIB1. In such aspects, the received SIB1 (e.g., the SIB1 710 (e.g., 810 in FIG. 8; 1110 in FIG. 11; 1207 in FIG. 12)) may be associated with the UL WUS 708 (e.g., 808 in FIG. 8; 920 in FIG. 9; 1008 in FIG. 10). In aspects, a TDD frequency domain resource (e.g., 950 in FIG. 9) for an UL BWP of the UL WUS 708 (e.g., 808 in FIG. 8; 920 in FIG. 9; 1008 in FIG. 10) may be based on an initial DL BWP associated with the MIB 706 (e.g., 806 in FIG. 8; 905 in FIG. 9; 1005 in FIG. 10; 1108 in FIG. 11; 1205 in FIG. 12). In such aspects, a RACH occasion (RO) for the UL WUS 708 (e.g., 808 in FIG. 8; 920 in FIG. 9; 1008 in FIG. 10) may be an initial RO of an initial UL BWP. In aspects, a CP length (e.g., 1010 in FIG. 10), associated with a determination of a RACH resource (e.g., 907 in FIG. 9; 1007 in FIG. 10), for an UL BWP of the UL WUS 708 (e.g., 808 in FIG. 8; 920 in FIG. 9; 1008 in FIG. 10) may be based on an SSB CP length (e.g., 1012 in FIG. 10) of an SSB (e.g., 906 in FIG. 9; 1006 in FIG. 10) that comprises the MIB 706 (e.g., 806 in FIG. 8; 905 in FIG. 9; 1005 in FIG. 10; 1108 in FIG. 11; 1205 in FIG. 12).

At 1404, the network node provides/transmits, for the UE and based on the UL WUS configuration, a SIB1. As an example, the provision/transmission may be performed by one or more of the component 199, the transceiver(s) 1646, and/or the antennas 1680 in FIG. 16. FIG. 7 illustrates, in the context of FIGS. 8, 9, 10, 11, 12 an example of the base station 704 (e.g., as a NES cell) providing/transmitting such a SIB1 for a UE (e.g., the UE 702).

The base station 704 may be configured to transmit/provide, and the UE 702 may be configured to receive, a SIB1 710 (e.g., 810 in FIG. 8; 1110 in FIG. 11; 1207 in FIG. 12). In aspects, the SIB1 710 (e.g., 810 in FIG. 8; 1110 in FIG. 11; 1207 in FIG. 12) may be based on the UL WUS configuration 707 (e.g., 807 in FIG. 8; 910 in FIG. 9), and the SIB1 710 (e.g., 810 in FIG. 8; 1110 in FIG. 11; 1207 in FIG. 12) that is received may be associated with the UL WUS 708 (e.g., 808 in FIG. 8; 920 in FIG. 9; 1008 in FIG. 10). In aspects, to receive the SIB1 710 (e.g., 810 in FIG. 8; 1110 in FIG. 11; 1207 in FIG. 12), the UE 702 may be configured to decode (e.g., at 1112 in FIG. 11) the SIB1 710 (e.g., 810 in FIG. 8; 1110 in FIG. 11; 1207 in FIG. 12) based on a control resource set 0 (CORESET0) and a search space 0 configuration indicated by the MIB 706 (e.g., 806 in FIG. 8; 905 in FIG. 9; 1005 in FIG. 10; 1108 in FIG. 11; 1205 in FIG. 12) based on a presence of an indication in the MIB 706 (e.g., 806 in FIG. 8; 905 in FIG. 9; 1005 in FIG. 10; 1108 in FIG. 11; 1205 in FIG. 12) that the SIB1 710 (e.g., 810 in FIG. 8; 1110 in FIG. 11; 1207 in FIG. 12) is an always-on SIB1 (e.g., via 814, 828 in FIG. 8). In aspects, to receive the SIB1 710 (e.g., 810 in FIG. 8; 1110 in FIG. 11; 1207 in FIG. 12), the UE 702 may be configured to receive the SIB1 710 (e.g., 810 in FIG. 8; 1110 in FIG. 11; 1207 in FIG. 12) from a source cell (e.g., the network node (e.g., the base station 704)) during a handover procedure. Is such aspects, the UE 702 may be configured to refrain (e.g., at 1116 in FIG. 11) from acquiring the SIB1 710 (e.g., 810 in FIG. 8; 1110 in FIG. 11; 1207 in FIG. 12) from a target cell. In some aspects, the SIB1 710 (e.g., 810 in FIG. 8; 1110 in FIG. 11; 1207 in FIG. 12) may be associated with a change in SIB1 operation between an always-on SIB1 (e.g., 828 in FIG. 8) and an on-demand SIB1 (e.g., 826 in FIG. 8), where the change in SIB1 operation may be based on an implicit indication(s) in communications. In aspects, an implicit indication may provide for the UE 702 to be configured to decode a PBCH (e.g., 1106 in FIG. 11) to re-obtain an UL WUS configuration (e.g., 707 in FIG. 7; 807 in FIG. 8; 910 in FIG. 9) and to then determine a SIB1 transmission mode. For example, the UE 702, to receive, as transmitted/provided by the base station 704, and based on the UL WUS configuration 707 (e.g., 807 in FIG. 8; 910 in FIG. 9), the SIB1 710 (e.g., 810 in FIG. 8; 1110 in FIG. 11; 1207 in FIG. 12), may be configured to determine (e.g., at 1206 in FIG. 12) a current SIB1 operation mode associated with the network node (e.g., the base station 704) based on decoding the MIB 706 (e.g., 806 in FIG. 8; 905 in FIG. 9; 1005 in FIG. 10; 1108 in FIG. 11; 1205 in FIG. 12), and to receive, from the network node (e.g., the base station 704), the SIB1 710 (e.g., 810 in FIG. 8; 1110 in FIG. 11; 1207 in FIG. 12) based on the current SIB1 operation mode. In some aspects, the SIB1 710 (e.g., 810 in FIG. 8; 1110 in FIG. 11; 1207 in FIG. 12) may be associated with a change in SIB1 operation between an always-on SIB1 (e.g., 826 in FIG. 8) and an on-demand SIB1 (e.g., 828 in FIG. 8), where the change in SIB1 operation is based on an explicit indication(s) in communications. In aspects, an explicit indication may provide for the UE 702 to be configured to determine a SIB1 transmission mode (e.g., always-on SIB1 (e.g., 826 in FIG. 8) or OD-SIB1 (e.g., 828 in FIG. 8)) based on a bit in paging DCI (e.g., 1208 in FIG. 12). In this case, UE may not decode the PBCH (e.g., 1106 in FIG. 11). For example, the UE 702, to receive, as transmitted/provided by the base station 704, and based on the UL WUS configuration 707 (e.g., 807 in FIG. 8; 910 in FIG. 9), the SIB1 710 (e.g., 810 in FIG. 8; 1110 in FIG. 11; 1207 in FIG. 12), may be configured to receive, from the network node (e.g., the base station 704), an indication of the change in SIB1 operation mode via a SIB1 operation mode indication bit in paging DCI (e.g., 1208 in FIG. 12).

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) 1524 communicates through the transceiver(s) 1522 via one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The cellular baseband processor(s) 1524 and the application processor(s) 1506 are configured to perform the various functions described supra based at least in part of the information stored in the memory. That is, the cellular baseband processor(s) 1524 and the application processor(s) 1506 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the component 198 may be configured to receive, from a network node, a MIB indicative of an UL WUS configuration. The component 198 may be configured to receive, from the network node and based on the UL WUS configuration, a SIB1. The component 198 may also be configured to transmit/provide, for the network node, an UL WUS in accordance with the UL WUS configuration, where the received SIB1 is associated with the UL WUS. The component 198 may also be configured to transmit/provide, for the network node, an UL WUS in accordance with the UL WUS configuration and based on an absence of an indication in the MIB that the SIB1 is an always-on SIB1, where the received SIB1 is associated with the UL WUS. The component 198 may be further configured to perform any of the aspects described in connection with the flowcharts in any of FIGS. 13, 14, and/or any of the aspects performed by a UE for any of FIGS. 4-12. The component 198 may be within the cellular baseband processor(s) 1524, the application processor(s) 1506, or both the cellular baseband processor(s) 1524 and the application processor(s) 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for receiving, from a network node, a MIB indicative of an UL WUS configuration. In one configuration, the apparatus 1504, and in particular the cellular baseband processor(s) 1524 and/or the application processor(s) 1506, may include means for receiving, from the network node and based on the UL WUS configuration, a SIB1. In one configuration, the apparatus 1504, and in particular the cellular baseband processor(s) 1524 and/or the application processor(s) 1506, may include means for transmitting/providing, for the network node, an UL WUS in accordance with the UL WUS configuration, where the received SIB1 is associated with the UL WUS. In one configuration, the apparatus 1504, and in particular the cellular baseband processor(s) 1524 and/or the application processor(s) 1506, may include means for transmitting/providing, for the network node, an UL WUS in accordance with the UL WUS configuration and based on an absence of an indication in the MIB that the SIB1 is an always-on SIB1, where the received SIB1 is associated with the UL WUS. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor 1612. The CU processor(s) 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor 1632. The DU processor(s) 1632 may include on-chip memory 1632′. In some aspects, the DU 1630 may further include additional memory modules 1634 and a communications interface 1638. The DU 1630 communicates with the RU 1640 through a fronthaul link. The RU 1640 may include at least one RU processor 1642. The RU processor(s) 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit/provide, for a UE, a MIB indicative of an UL WUS configuration. The component 199 may be configured to transmit/provide, for the UE and based on the UL WUS configuration, a SIB1. The component 199 may also be configured to receive, from the UE, an UL WUS in accordance with the UL WUS configuration, where the transmitted SIB1 is associated with the UL WUS. The component 199 may also be configured to receive, from the UE, an UL WUS in accordance with the UL WUS configuration and based on an absence of an indication in the MIB that the SIB1 is an always-on SIB1, where the transmitted SIB1 is associated with the UL WUS. The component 199 may be further configured to perform any of the aspects described in connection with the flowcharts in any of FIGS. 13, 14, and/or any of the aspects performed by a network node (e.g., a base station, gNB, NES node/cell, etc.) for any of FIGS. 4-12. The component 199 may be within one or more processors of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 may include means for transmitting/providing, for a UE, a MIB indicative of an UL WUS configuration. In one configuration, the network entity 1602 may include means for transmitting/providing, for the UE and based on the UL WUS configuration, a SIB1. In one configuration, the network entity 1602 may include means for receiving, from the UE, an UL WUS in accordance with the UL WUS configuration, where the transmitted SIB1 is associated with the UL WUS. In one configuration, the network entity 1602 may include means for receiving, from the UE, an UL WUS in accordance with the UL WUS configuration and based on an absence of an indication in the MIB that the SIB1 is an always-on SIB1, where the transmitted SIB1 is associated with the UL WUS. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

A UE may receive various types of SI, e.g., via SIB1, in a wireless communication network, e.g., 5G NR or others, through different channels and mechanisms. An anchor cell (e.g., a network node) may provide universal coverage for an idle/inactive state UE supporting on-demand SIB1, e.g., the anchor cell provides always-on SSB/SIB1. An overlaid OD-SIB1 cell may provide better service than the anchor cell for a connected UE. For instance, depending on the UE location, an OD-SIB1 cell may provide better signal quality than the anchor cell, and the OD-SIB1 cell may have larger available bandwidth than the anchor cell. The anchor cell may provide a configuration for an OD-SIB1 procedure for an overlaid OD-SIB1 cell, e.g., via an UL WUS signal configuration and PDCCH/PDSCH configuration for OD-SIB1 transmission. In some cases, an idle/inactive state UE may camp on a cell and monitor SSBs for cell selection/reselection, acquisition/reacquisition of MIB/SIB, monitoring of paging for SI updates and DL data arrival, connection setup, location registration/update, etc., as well as, monitoring a neighbor cell(s) SSB for cell selection/reselection. However, a deployed OD-SIB 1 cell may be enabled to provide an UL WUS configuration for an idle/inactive state UE; rather, an overlaid anchor cell would provide the UL WUS configuration for the OD-SIB1 cell. In cell reselection scenarios, a UE may obtain an UL WUS configuration of a new serving cell, if the new serving cell is an OD-SIB1 cell, for proper operations. If the UL WUS configuration is provided by the anchor cell and not the OD-SIB1 cell, the UE may switch to the anchor cell to obtain UL WUS configuration during cell reselection for proper operations. If the UL WUS configuration is provided via a current serving cell, such a scenario would increase backhaul coordination and SIB signaling overhead in order to provide the UL WUS configuration for multiple neighbor cells. For current and future deployments, e.g., 5G, 6G deployments, there is a need to support standalone OD-SIB1 operations without an anchor cell.

Aspects herein standalone OD-SIB1 configurations provide for support of standalone OD-SIB1 operations with a cell on which the UE camps, e.g., a NES cell where the UE is in an idle/inactive state, and without an anchor cell. Aspects bypass communications with an anchor cell and reduce UE cell switching by providing the UL WUS configuration from an OD-SIB1 cell. Aspects also reduce backhaul coordination and SIB signaling overhead by providing the UL WUS configuration in a MIB from an OD-SIB1 cell.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a user equipment (UE), comprising: receiving, from a network node, a master information block (MIB) indicative of an uplink (UL) wake up signal (WUS) configuration; and receiving, from the network node and based on the UL WUS configuration, a system information block type 1 (SIB1).
Aspect 2 is the method of aspect 1, further comprising: providing, for the network node, an UL WUS in accordance with the UL WUS configuration, wherein the received SIB1 is associated with the UL WUS.
Aspect 3 is the method of any of aspects 1 and 2, wherein a synchronized signal block (SSB) comprises the MIB, wherein the UL WUS configuration is associated with a configuration index for a set of UL WUS configurations, wherein a single codepoint of the MIB is associated with the UL WUS configuration.
Aspect 4 is the method of any of aspects 1 to 3, wherein the UL WUS configuration is associated with a configuration for at least one of a message type 1 (MSG1) frequency start offset, a number of physical random access channel (PRACH) preambles, a PRACH configuration index, a zero correlation zone configuration, a power control parameter, a random access response (RAR) window size, a PRACH subcarrier spacing (SCS), a non-PRACH SCS, a set of absolute radio-frequency channel numbers (ARFCNs) associated with a set of synchronization raster points, or a frequency offset.
Aspect 5 is the method of aspect 4, wherein a time division duplex (TDD) frequency domain resource for an UL bandwidth part (BWP) of an UL WUS is based on the MSG1 frequency start offset relative to a lowest physical resource block (PRB) associated with a synchronized signal block (SSB) that comprises the MIB, wherein the MIB is indicative of the MSG1 frequency start offset.
Aspect 6 is the method of any of aspects 4 and 5, wherein a frequency division duplex (FDD) frequency domain resource of an UL WUS is based on an ARFCN, of the set of ARFCNs, associated with a first tone of a random access channel (RACH) resource in the frequency domain, wherein the MIB is indicative of the ARFCN.
Aspect 7 is the method of any of aspects 4 to 6, wherein an SCS of a PRACH is based on: a pre-defined SCS associated with a frequency range or a band of the network node; or the PRACH SCS among a set of PRACH SCSs associated with the frequency range or the band of the network node, wherein the MIB is indicative of the PRACH SCS among the set of PRACH SCSs.
Aspect 8 is the method of any of aspects 4 to 6, wherein an SCS of an UL channel other than a PRACH is based on: a first SCS of a synchronized signal block (SSB) that comprises the MIB or a second SCS of an initial downlink (DL) bandwidth part (BWP) associated with the MIB; or the non-PRACH SCS among a set of non-PRACH SCSs associated with a frequency range or a band of the network node, wherein the MIB is indicative of the non-PRACH SCS among the set of non-PRACH SCSs.
Aspect 9 is the method of any of aspects 4 to 8, wherein receiving the MIB includes: receiving, from the network node, a physical broadcast channel (PBCH) during a cell selection, a cell reselection, or a handover procedure in which a provision of the SIB1 for a target cell from a source cell is absent; and wherein receiving the SIB1 includes: receiving the SIB1 from the target cell based on a decode of the PBCH.
Aspect 10 is the method of aspect 9, wherein receiving the SIB1 includes: decoding the SIB1 based on a control resource set 0 (CORESET0) and a search space 0 configuration indicated by the MIB based on a presence of an indication in the MIB that the SIB1 is an always-on SIB1.
Aspect 11 is the method of any of aspects 9 and 10, further comprising: providing, for the network node, an UL WUS in accordance with the UL WUS configuration and based on an absence of an indication in the MIB that the SIB1 is an always-on SIB1, wherein the received SIB1 is associated with the UL WUS.
Aspect 12 is the method of any of aspects 1 to 11, wherein receiving the SIB1 includes: receiving the SIB1 from a source cell during a handover procedure; and refraining from acquiring the SIB1 from a target cell.
Aspect 13 is the method of any of aspects 1 to 12, wherein the network node is a network energy savings node; or wherein the MIB is indicative of an always-on SIB1 transmission configuration.
Aspect 14 is the method of any of aspects 1 to 4 and 6 to 13, wherein a time division duplex (TDD) frequency domain resource for an UL bandwidth part (BWP) of an UL WUS is based on an initial downlink (DL) BWP associated with the MIB, wherein a random access channel (RACH) occasion (RO) for the UL WUS is an initial RO of an initial UL BWP.
Aspect 15 is the method of any of aspects 1 to 14, wherein a cyclic prefix (CP) length, associated with a determination of a RACH resource, for an UL bandwidth part (BWP) of an UL WUS is based on a synchronized signal block (SSB) CP length of an SSB that comprises the MIB.
Aspect 16 is the method of any of aspects 1 to 15, wherein the SIB1 is associated with a change in a SIB1 operation mode between an always-on SIB1 and an on-demand SIB1, wherein the change in the SIB1 operation mode is based on implicit communication; wherein receiving, from the network node and based on the UL WUS configuration, the SIB1 includes: determining a current SIB1 operation mode associated with the network node based on decoding the MIB; and receiving, from the network node, the SIB1 based on the current SIB1 operation mode.
Aspect 17 is the method of any of aspects 1 to 15, wherein the SIB1 is associated with a change in a SIB1 operation mode between an always-on SIB1 and an on-demand SIB1, wherein the change in the SIB1 operation mode is based on an explicit communication; wherein receiving, from the network node and based on the UL WUS configuration, the SIB1 includes: receiving, from the network node, an indication of the change in the SIB1 operation mode via a SIB1 operation mode indication bit in paging downlink control information (DCI).
Aspect 18 is the method of any of aspects 1 to 17, wherein the method is performed by a wireless communication device, wherein the wireless communication device comprises at least one processor and at least one of an antenna or a transceiver coupled to the at least one processor, wherein receiving the MIB or receiving the SIB1 is performed by the at least one processor via at least one of the antenna or the transceiver.
Aspect 19 is an apparatus for wireless communication at a user equipment (UE), comprising: at least one memory; and at least one processor coupled to the at least one memory, the at least one processor is configured to perform the method of any of aspects 1 to 18.
Aspect 20 is an apparatus for wireless communication at a user equipment (UE), comprising means for performing each step in the method of any of aspects 1 to 18.
Aspect 21 is the apparatus of any of aspects 19 to 20, further comprising a transceiver configured to receive or to transmit in association with the method of any of aspects 1 to 18.
Aspect 22 is a computer-readable medium (e.g., a non-transitory computer-readable medium) storing computer executable code at a user equipment (UE), the code when executed by at least one processor causes the at least one processor to perform the method of any of aspects 1 to 18.
Aspect 23 is a method of wireless communication at a network node, comprising: transmitting, for a user equipment (UE), a master information block (MIB) indicative of an uplink (UL) wake up signal (WUS) configuration; and transmitting, for the UE and based on the UL WUS configuration, a system information block type 1 (SIB1).
Aspect 24 is a method of aspect 23, further comprising: providing, for the network node, an UL WUS in accordance with the UL WUS configuration, wherein the received SIB1 is associated with the UL WUS.
Aspect 25 is the method of any of aspects 23 and 24, wherein the network node is a network energy savings node.
Aspect 26 is an apparatus for wireless communication at a network node, comprising: at least one memory; and at least one processor coupled to the at least one memory, the at least one processor is configured to perform the method of any of aspects 23 to 25.
Aspect 27 is an apparatus for wireless communication at a network node, comprising means for performing each step in the method of any of aspects 23 to 25.
Aspect 28 is the apparatus of any of aspects 26 to 28, further comprising a transceiver configured to receive or to transmit in association with the method of any of aspects 23 to 25.
Aspect 29 is a computer-readable medium (e.g., a non-transitory computer-readable medium) storing computer executable code at a network node, the code when executed by at least one processor causes the at least one processor to perform the method of any of aspects 23 to 25.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
receive, from a network node, a master information block (MIB) indicative of an uplink (UL) wake up signal (WUS) configuration; and
receive, from the network node and based on the UL WUS configuration, a system information block type 1 (SIB1).

2. The apparatus of claim 1, wherein the at least one processor is further configured to:
provide, for the network node, an UL WUS in accordance with the UL WUS configuration, wherein the received SIB1 is associated with the UL WUS.

3. The apparatus of claim 1, wherein a synchronized signal block (SSB) comprises the MIB, wherein the UL WUS configuration is associated with a configuration index for a set of UL WUS configurations, wherein a single codepoint of the MIB is associated with the UL WUS configuration.

4. The apparatus of claim 1, wherein the UL WUS configuration is associated with a configuration for at least one of a message type 1 (MSG1) frequency start offset, a number of physical random access channel (PRACH) preambles, a PRACH configuration index, a zero correlation zone configuration, a power control parameter, a random access response (RAR) window size, a PRACH subcarrier spacing (SCS), a non-PRACH SCS, a set of absolute radio-frequency channel numbers (ARFCNs) associated with a set of synchronization raster points, or a frequency offset.

5. The apparatus of claim 4, wherein a time division duplex (TDD) frequency domain resource for an UL bandwidth part (BWP) of an UL WUS is based on the MSG1 frequency start offset relative to a lowest physical resource block (PRB) associated with a synchronized signal block (SSB) that comprises the MIB, wherein the MIB is indicative of the MSG1 frequency start offset.

6. The apparatus of claim 4, wherein a frequency division duplex (FDD) frequency domain resource of an UL WUS is based on an ARFCN, of the set of ARFCNs, associated with a first tone of a random access channel (RACH) resource in the frequency domain, wherein the MIB is indicative of the ARFCN.

7. The apparatus of claim 4, wherein an SCS of a PRACH is based on:
a pre-defined SCS associated with a frequency range or a band of the network node; or
the PRACH SCS among a set of PRACH SCSs associated with the frequency range or the band of the network node, wherein the MIB is indicative of the PRACH SCS among the set of PRACH SCSs.

8. The apparatus of claim 4, wherein an SCS of an UL channel other than a PRACH is based on:
a first SCS of a synchronized signal block (SSB) that comprises the MIB or a second SCS of an initial downlink (DL) bandwidth part (BWP) associated with the MIB; or
the non-PRACH SCS among a set of non-PRACH SCSs associated with a frequency range or a band of the network node, wherein the MIB is indicative of the non-PRACH SCS among the set of non-PRACH SCSs.

9. The apparatus of claim 4, wherein to receive the MIB, the at least one processor is configured to:
receive, from the network node, a physical broadcast channel (PBCH) during a cell selection, a cell reselection, or a handover procedure in which a provision of the SIB1 for a target cell from a source cell is absent; and
wherein to receive the SIB1, the at least one processor is configured to:
receive the SIB1 from the target cell based on a decode of the PBCH.

10. The apparatus of claim 9, wherein to receive the SIB1, the at least one processor is configured to:
decode the SIB1 based on a control resource set 0 (CORESET0) and a search space 0 configuration indicated by the MIB based on a presence of an indication in the MIB that the SIB1 is an always-on SIB1.

11. The apparatus of claim 9, wherein the at least one processor is further configured to:
provide, for the network node, an UL WUS in accordance with the UL WUS configuration and based on an absence of an indication in the MIB that the SIB1 is an always-on SIB1, wherein the received SIB1 is associated with the UL WUS.

12. The apparatus of claim 1, wherein to receive the SIB1, the at least one processor is configured to:
receive the SIB1 from a source cell during a handover procedure; and
refrain from acquiring the SIB1 from a target cell.

13. The apparatus of claim 1, wherein the network node is a network energy savings node; or
wherein the MIB is indicative of an always-on SIB1 transmission configuration.

14. The apparatus of claim 1, wherein a time division duplex (TDD) frequency domain resource for an UL bandwidth part (BWP) of an UL WUS is based on an initial downlink (DL) BWP associated with the MIB, wherein a random access channel (RACH) occasion (RO) for the UL WUS is an initial RO of an initial UL BWP.

15. The apparatus of claim 1, wherein a cyclic prefix (CP) length, associated with a determination of a RACH resource, for an UL bandwidth part (BWP) of an UL WUS is based on a synchronized signal block (SSB) CP length of an SSB that comprises the MIB.

16. The apparatus of claim 1, wherein the SIB1 is associated with a change in a SIB1 operation mode between an always-on SIB1 and an on-demand SIB1, wherein the change in the SIB1 operation mode is based on implicit communication;
wherein to receive, from the network node and based on the UL WUS configuration, the SIB1, the at least one processor is configured to:
determine a current SIB1 operation mode associated with the network node based on decoding the MIB; and
receive, from the network node, the SIB1 based on the current SIB1 operation mode.

17. The apparatus of claim 1, wherein the SIB1 is associated with a change in a SIB1 operation mode between an always-on SIB1 and an on-demand SIB1, wherein the change in the SIB1 operation mode is based on an explicit communication;
wherein to receive, from the network node and based on the UL WUS configuration, the SIB1, the at least one processor is configured to:
receive, from the network node, an indication of the change in the SIB1 operation mode via a SIB1 operation mode indication bit in paging downlink control information (DCI).

18. The apparatus of claim 1, further comprising at least one of an antenna or a transceiver coupled to the at least one processor, wherein to receive the MIB or to receive the SIB1, the at least one processor is configured to receive the MIB or to receive the SIB1 via at least one of the antenna or the transceiver.

19. An apparatus for wireless communication at a network node, comprising:
at least one memory; and
at least one processor coupled to the at least one memory and, based at least in part on information stored in the at least one memory, the at least one processor is configured to:
transmit, for a user equipment (UE), a master information block (MIB) indicative of an uplink (UL) wake up signal (WUS) configuration; and
transmit, for the UE and based on the UL WUS configuration, a system information block type 1 (SIB1).

20. A method of wireless communication at a user equipment (UE), comprising:
receiving, from a network node, a master information block (MIB) indicative of an uplink (UL) wake up signal (WUS) configuration; and
receiving, from the network node and based on the UL WUS configuration, a system information block type 1 (SIB1).
